(19) United States
(12) Patent Application Publication
(10) Pub. No.: US 2023/0224967 A1
(43) Pub. Date: Jul. 13, 2023

(54) METHOD AND APPARATUS FOR CHANNEL OCCUPANCY INDICATION ON SIDELINK

(71) Applicant: Samsung Electronics Co., Ltd., Suwon-si (KR)

(72) Inventors: Hongbo Si, Plano, TX (US); Emad N. Farag, Flanders, NJ (US); Carmela Cozzo, San Diego, CA (US); Kyeongin Jeong, Allen, TX (US); Jinyoung Oh, Plano, TX (US)

(21) Appl. No.: 18/145,741

(22) Filed: Dec. 22, 2022

Related U.S. Application Data
(60) Provisional application No. 63/297,539, filed on Jan. 7, 2022.
(60) Provisional application No. 63/321,498, filed on Mar. 18, 2022.
(60) Provisional application No. 63/324,904, filed on Mar. 29, 2022.

(51) Int. Cl. H04W 74/08; H04W 72/25

(52) U.S. Cl. CPC H04W 74/0816; H04W 74/0875; H04W 72/25

(57) ABSTRACT

Methods and apparatuses for channel occupancy indication on a sidelink (SL) in a wireless communication system. A method of operating user equipment (UE) includes receiving a SL control information (SCI) format over a sidelink channel; determining, from the SCI format, at least one of: time domain information for a channel occupancy, frequency domain information for the channel occupancy, and a SL channel access procedure. The method further includes performing the SL channel access procedure before a sidelink transmission; and transmitting, upon successfully performing the sidelink channel access procedure, the SL transmission over the SL channel within the channel occupancy based on the time domain information or the frequency domain information for the channel occupancy.

### CROSS-REFERENCE TO RELATED APPLICATIONS AND CLAIM OF PRIORITY

The present application claims priority to:
U.S. Provisional Patent Application No. 63/297,539, filed on Jan. 7, 2022;
U.S. Provisional Patent Application No. 63/321,498, filed on Mar. 18, 2022; and
U.S. Provisional Patent Application No. 63/324,904, filed on Mar. 29, 2022. The contents of the above-identified patent documents are incorporated herein by reference.

### TECHNICAL FIELD

The present disclosure relates generally to wireless communication systems and, more specifically, the present disclosure relates to a channel occupancy indication on a sidelink (SL) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a channel occupancy indication on a SL in a wireless communication system.

In one embodiment, a user equipment (UE) in a wireless communication system operating with a shared spectrum channel access is provided. The UE includes a transceiver configured to receive a sidelink control information (SCI) format over a sidelink channel and a processor operably coupled to the transceiver. The processor configured to determine, from the SCI format, at least one of: time domain information for a channel occupancy, frequency domain information for the channel occupancy, and a sidelink channel access procedure; and perform the sidelink channel access procedure before a sidelink transmission. The transceiver is further configured to transmit, upon successfully performing the sidelink channel access procedure, the sidelink transmission over the sidelink channel within the channel occupancy based on the time domain information or the frequency domain information for the channel occupancy.

In another embodiment, a method of UE in a wireless communication system operating with a shared spectrum channel access is provided. The method includes receiving a SCI format over a sidelink channel; determining, from the SCI format, at least one of: time domain information for a channel occupancy, frequency domain information for the channel occupancy, and a sidelink channel access procedure. The method further includes performing the sidelink channel access procedure before a sidelink transmission; and transmitting, upon successfully performing the sidelink channel access procedure, the sidelink transmission over the sidelink channel within the channel occupancy based on the time domain information or the frequency domain information for the channel occupancy.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of resource pool in Rel-16 NR V2X according to embodiments of the present disclosure;

FIG. 7 illustrates an example of slot structure for SL transmission and reception according to embodiments of the present disclosure;

FIG. 8 illustrates an example of time domain resource determination for PSFCH according to embodiments of the present disclosure;

FIG. 9 illustrates an example of frequency domain resource determination for PSFCH according to embodiments of the present disclosure;

FIG. 10 illustrates an example of single field indication in the DCI according to embodiments of the present disclosure;

FIG. 11 illustrates an example of two fields indication in the DCI according to embodiments of the present disclosure;

FIG. 12 illustrates an example of one or multiple fields indication in the DCI according to embodiments of the present disclosure;

FIG. 13 illustrates an example of single field indication in the DCI according to embodiments of the present disclosure;

FIG. 14 illustrates an example of two fields indication in the DCI according to embodiments of the present disclosure;

FIG. 15 illustrates an example of one or multiple fields indication in the DCI according to embodiments of the present disclosure;

FIG. 16 illustrates a flowchart of a method for a UE procedure for setting an energy detection threshold using the first type of maximum energy detection threshold according to embodiments of the present disclosure;

FIG. 17 illustrates a flowchart of a method for a UE procedure for setting an energy detection threshold using the second type of maximum energy detection threshold according to embodiments of the present disclosure;

FIG. 18 illustrates a flowchart of a method for a UE procedure for setting an energy detection threshold using the first type of maximum energy detection threshold and/or the offset for the first type of maximum energy detection threshold according to embodiments of the present disclosure;

FIG. 19 illustrates a flowchart of a method for a UE procedure for setting an energy detection threshold using the second type of maximum energy detection threshold and/or the offset for the second type of maximum energy detection threshold according to embodiments of the present disclosure;

FIG. 20 illustrates a flowchart of a method for a UE procedure for sidelink transmission based on the maximum ED thresholds according to embodiments of the present disclosure; and

FIG. 21 illustrates a flowchart of a method for a UE procedure for sidelink transmission based on the maximum ED thresholds according to embodiments of the present disclosure.

### DETAILED DESCRIPTION

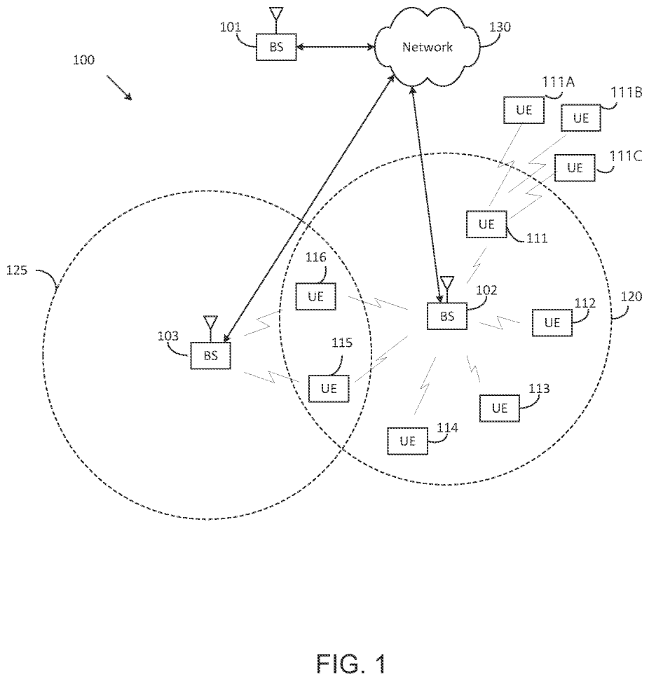

FIG. 1 through FIG. 21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.6.0, “NR; Physical channels and modulation”; 3GPP TS 38.212 v16.6.0, “NR; Multiplexing and Channel coding”; 3GPP TS 38.213 v16.6.0, “NR; Physical Layer Procedures for Control”; 3GPP TS 38.214 v16.6.0, “NR; Physical Layer Procedures for Data”; and 3GPP TS 38.331 v16.5.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an inter-UE co-ordination signaling in a wireless communication system. In certain embodiments, and one or more of the gNBs 101-103 includes circuitry, programing, or a combination thereof, for an inter-UE co-ordination signaling in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

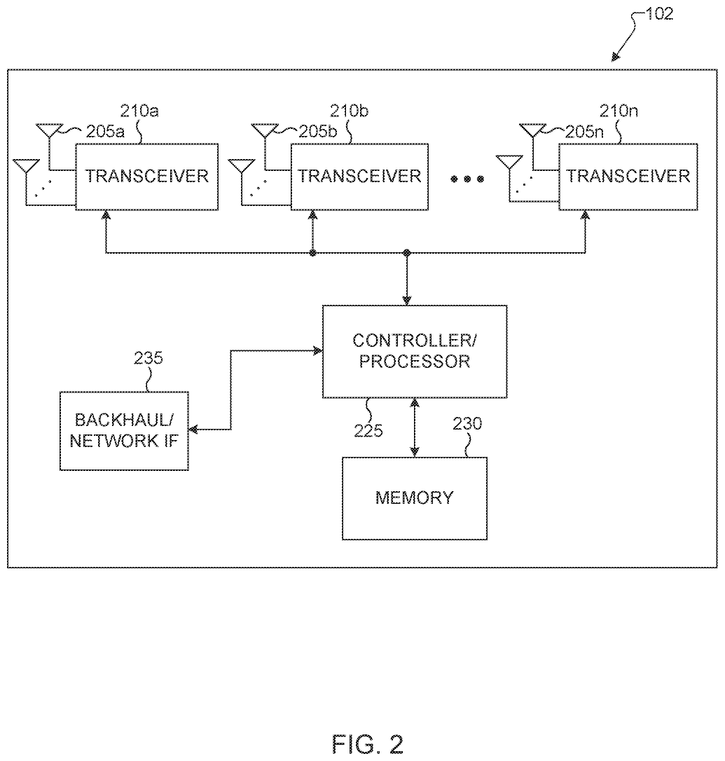

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for a channel occupancy indication on a sidelink in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

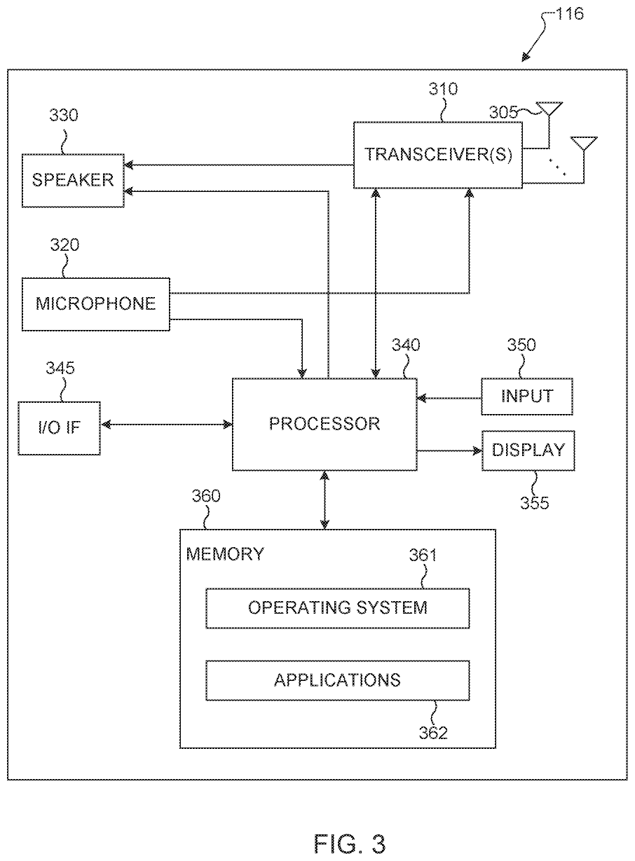

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a channel occupancy indication on a sidelink in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

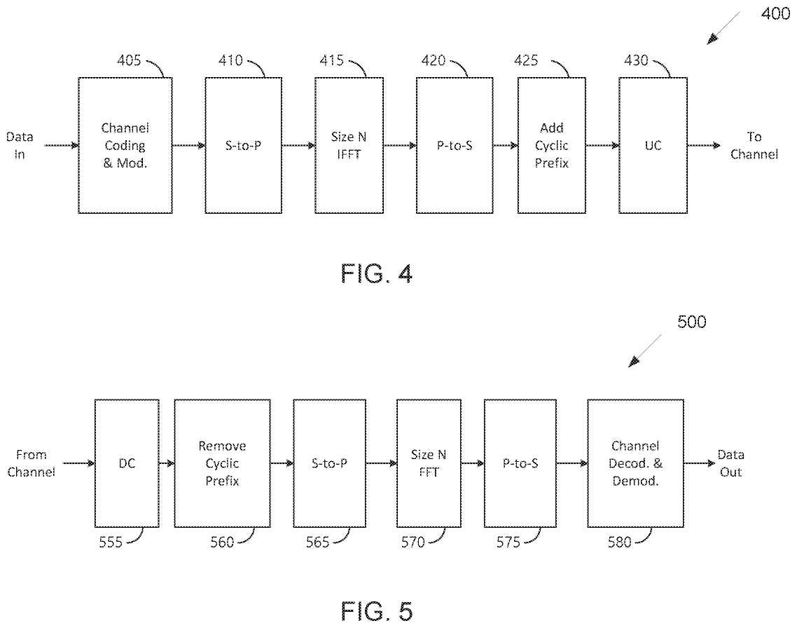

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNB s 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

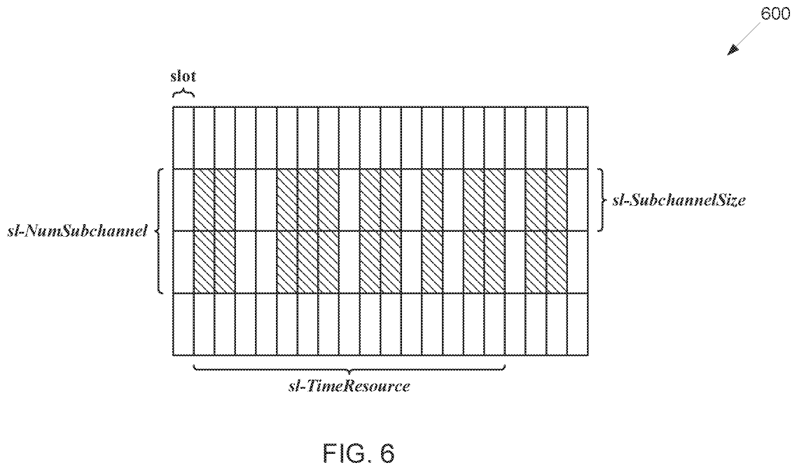

In Rel-16 NR V2X, transmission and reception of SL signals and channels are based on resource pool(s) confined in the configured SL bandwidth part (BWP). In the frequency domain, a resource pool consists of a (pre-)configured number (e.g., sl-NumSubchannel) of contiguous sub-channels, wherein each sub-channel consists of a set of contiguous resource blocks (RBs) in a slot with size (pre-)configured by higher layer parameter (e.g., sl-SubchannelSize). In time domain, slots in a resource pool occur with a periodicity of 10240 ms, and slots including S-SSB, non-UL slots, and reserved slots are not applicable for a resource pool. The set of slots for a resource pool is further determined within the remaining slots, based on a (pre-)configured bitmap (e.g., sl-TimeResource). An illustration of a resource pool is shown in FIG. 6.

FIG. 6 illustrates an example of resource pool in Rel-16 NR V2X 600 according to embodiments of the present disclosure. The embodiment of the resource pool in Rel-16 NR V2X 600 illustrated in FIG. 6 is for illustration only.

A transmission and reception of physical sidelink shared channel (PSSCH), physical a sidelink control channel (PSCCH), and a physical sidelink feedback channel (PSFCH) are confined within and associated with a resource pool, with parameters (pre-)configured by higher layers (e.g., SL-PSSCH-Config, SL-PSCCH-Config, and SL-PSFCH-Config, respectively).

A UE may transmit the PSSCH in consecutive symbols within a slot of the resource pool, and PSSCH resource allocation starts from the second symbol configured for sidelink, e.g., startSLsymbol+1, and the first symbol configured for sidelink is duplicated from the second configured for sidelink, for AGC purpose. The UE may not transmit PSSCH in symbols not configured for sidelink, or in symbols configured for PSFCH, or in the last symbol configured for sidelink, or in the symbol immediately preceding the PSFCH. The frequency domain resource allocation unit for PSSCH is the sub-channel, and the sub-channel assignment is determined using the corresponding field in the associated SCI.

For transmitting a PSCCH, the UE can be provided a number of symbols (either 2 symbols or 3 symbols) in a resource pool (e.g., sl-TimResourcePSCCH) starting from the second symbol configured for sidelink, e.g., startSLsymbol+1; and further provided a number of RBs in the resource pool (e.g., sl-FreqResourcePSCCH) starting from the lowest RB of the lowest sub-channel of the associated PSSCH.

The UE can be further provided a number of slots (e.g., sl-PSFCH-Period) in the resource pool for a period of PSFCH transmission occasion resources, and a slot in the resource pool is determined as containing a PSFCH transmission occasion if the relative slot index within the resource pool is an integer multiple of the period of PSFCH transmission occasion. PSFCH is transmitted in two contiguous symbols in a slot, wherein the second symbol is with index startSLsymbols+lengthSLsymbols−2, and the two symbols are repeated. In frequency domain, PSFCH is transmitted in a single RB, wherein OCC can be applied within the RB for multiplexing, and the location of the RB is determined based on an indication of a bitmap (e.g., sl-PSFCH-RB-Set), and the selection of PSFCH resource is according to the source ID and destination ID.

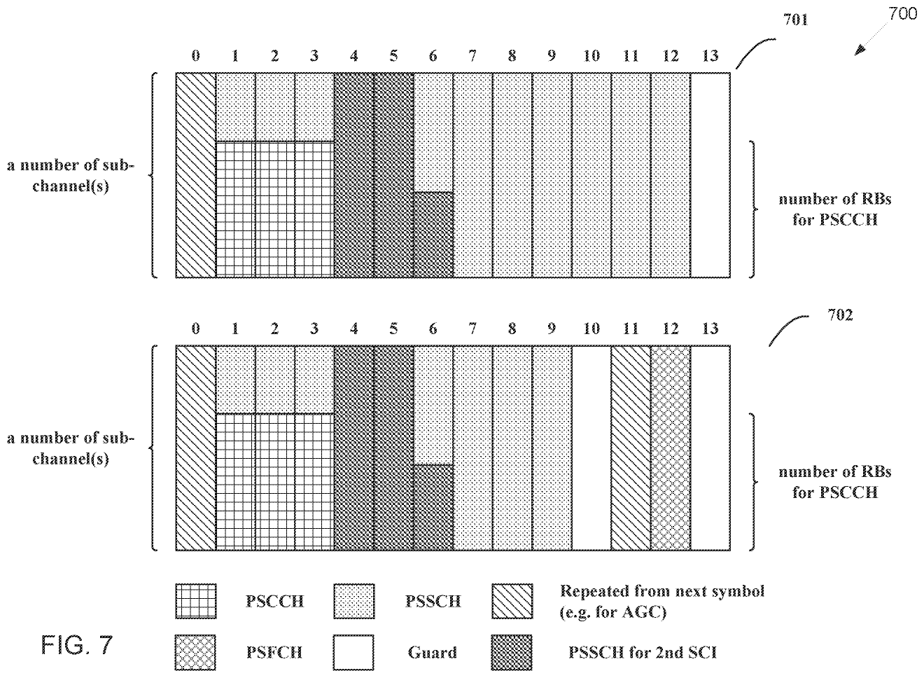

The first symbol including PSSCH and PSCCH is duplicated for AGC purpose. An illustration of the slot structure including PSSCH and PSCCH is shown in 701 of FIG. 7, and the slot structure including PSSCH, PSCCH and PSFCH is shown in 702 of FIG. 7.

FIG. 7 illustrates an example of slot structure for SL transmission and reception 700 according to embodiments of the present disclosure. The embodiment of the slot structure for SL transmission and reception 700 illustrated in FIG. 7 is for illustration only.

For a sidelink operation on unlicensed or shared spectrum, there is a need to indicate channel occupancy information, in both time and frequency domain, such that another node not initializing the channel occupancy can receive the channel occupancy information and share the channel. Meanwhile, there is also a need to indicate the number of PSCCH candidate locations to monitor, which can be used for sidelink operating on unlicensed or shared spectrum, but not limited to sidelink operating on unlicensed or shared spectrum.

The present disclosure provides embodiments for supporting indication of channel occupancy related information in a sidelink control information. More precisely, the following components are focused on the present disclosure: (1) a time domain channel occupancy indication; (2) a frequency domain channel occupancy indication; (3) a PSCCH configuration indication; and (4) an SCI format to include the indication(s).

In one embodiment, an indication of time domain information on channel occupancy can be included in a sidelink control information (SCI) format, wherein the SCI format can be according to an example of another embodiment in this disclosure.

In one example, the time domain information can be a remaining channel occupancy duration in the unit of symbols from a first symbol of the slot where a UE detects the SCI format.

In another example, the time domain information can be a remaining channel occupancy duration in the unit of slots from the slot where a UE detects the SCI format.

In one embodiment, the time domain information on the channel occupancy can be associated with a source ID (e.g., a ID of a source transmitter UE).

For one instance, when a UE receives a SCI format (e.g. SCI format 2-A and/or format 2-B and/or format 2-C), the time domain information on the channel occupancy can be associated with a source ID given by the “source ID” field as included in the SCI format. A UE that receives the time domain information on the channel occupancy can determine such time domain information is applicable for the channel occupancy utilized for SL transmission from the transmitter UE with the identity provided by the “source ID” field.

For another instance, when a UE receives a SCI format, the time domain information on the channel occupancy can be associated with a source ID field as included in the same SCI format that includes the time domain information. A UE that receives the time domain information on the channel occupancy can determine such time domain information is applicable for the channel occupancy utilized for SL transmission from the transmitter UE with the identity provided by the source ID field included in the same SCI format that includes the time domain information.

For yet another instance, when a UE receives a SCI format, the time domain information on the channel occupancy can be associated with a source ID included in a RNTI that scrambles the SCI format. A UE that receives the time domain information on the channel occupancy can determine such time domain information is applicable for the channel occupancy utilized for SL transmission from the transmitter with the identity provided by the source ID included in the RNTI. In one aspect, the SCI format can be included in the PSCCH. In another aspect, the SCI format can be included in the PSSCH.

For yet another instance, when a UE initiates a channel occupancy by completing a channel access procedure, the source ID associated with the time domain information on the channel occupancy is associated with the UE itself (e.g., the source ID is associated with the UE initiates the channel occupancy).

For yet another instance, the source ID associated with the time domain information on the channel occupancy may not have to refer to the transmitter of the transmission including the SCI. For a sub-instance, the source ID associated with the time domain information on the channel occupancy can refer to a first UE (e.g., the UE initializing the channel occupancy), and the SCI including the time domain information on the channel occupancy can be transmitted from a second UE to a third UE, wherein the second UE uses the shared channel occupancy from the first UE and performs sidelink transmission to the third UE.

In another embodiment, the time domain information on the channel occupancy can be associated with a CO-sharing ID.

For one instance, when a UE receives a SCI format (e.g., SCI format 2-A and/or format 2-B and/or format 2-C), the time domain information on the channel occupancy can be associated with the “destination ID” field as included in the SCI format (e.g., the CO-sharing ID can be represented by the “destination ID”). A UE that receives the time domain information on the channel occupancy can determine such time domain information is applicable for the channel occupancy utilized for SL transmission to the receiver(s) with the identity provided by the “destination ID” field.

For another instance, when a UE receives a SCI format, the time domain information on the channel occupancy can be associated with a CO-sharing ID field as included in the same SCI format that includes the time domain information (e.g., the CO-sharing ID field may be different from “destination ID” field). A UE that receives the time domain information on the channel occupancy can determine such time domain information is applicable for the channel occupancy utilized for SL transmission to the receiver(s) with the identity provided by the CO-sharing ID field included in the same SCI format that includes the time domain information.

For yet another instance, when a UE receives a SCI format, the time domain information on the channel occupancy can be associated with a CO-sharing ID included in a RNTI that scrambles the SCI format. A UE that receives the time domain information on the channel occupancy can determine such time domain information is applicable for the channel occupancy utilized for SL transmission to the receiver(s) with the identity provided by CO-sharing ID. In one aspect, the SCI format can be included in the PSCCH. In another aspect, the SCI format can be included in the PSSCH.

For yet another instance, when a UE initializes a channel occupancy by performing a channel access procedure, the CO-sharing ID associated with the time domain information on the channel occupancy is the one or more UEs as the receiver(s) of the SL transmissions performed by the UE.

In yet another embodiment, a UE that receives the time domain information on the channel occupancy can further share the channel occupancy to start a new SL transmission within the remaining duration of the channel occupancy, if a condition on at least one ID is satisfied.

For one instance, the UE that receives the time domain information on the channel occupancy can further share the channel occupancy to start a new SL transmission within the remaining duration of the channel occupancy, if the CO-sharing ID associated with the channel occupancy (e.g., according to the instance of this disclosure) corresponds to the UE or includes the UE.

For another instance, the UE that receives the time domain information on the channel occupancy can further share the channel occupancy to start a new SL transmission within the remaining duration of the channel occupancy, if the CO-sharing ID associated with the channel occupancy corresponds to the UE (e.g., according to the instance of this disclosure) corresponds to the UE or includes the UE, and/or the source ID associated with the channel occupancy corresponds to or is included in the receiver(s) of the new SL transmission.

In yet another embodiment, a UE can receive multiple time domain information on the channel occupancy included in multiple SCIs at the same time, and determine a combined time domain information on the channel occupancy based on multiple received time domain information on the channel occupancy.

In one instance, the UE determines the combined remaining channel occupancy duration for a channel as the minimum of remaining channel occupancy duration determined based on the received multiple remaining channel occupancy durations for the channel included in the multiple SCIs.

In another instance, the UE determines the combined remaining channel occupancy duration for a channel as the maximum of remaining channel occupancy duration determined based on the received multiple remaining channel occupancy durations for the channel included in the multiple SCIs.

In yet another instance, the UE determines the combined remaining channel occupancy duration for a channel as the minimum of remaining channel occupancy duration determined based on the received multiple remaining channel occupancy durations for the channel included in the multiple SCIs, wherein the source ID associated with the received multiple remaining channel occupancy durations are the same.

In yet another instance, the UE determines the combined remaining channel occupancy duration for a channel as the maximum of remaining channel occupancy duration determined based on the received multiple remaining channel occupancy durations for the channel included in the multiple SCIs, wherein the source ID associated with the received multiple remaining channel occupancy durations are the same.

In yet another instance, the UE determines the combined remaining channel occupancy duration for a channel as the minimum of remaining channel occupancy duration determined based on the received multiple remaining channel occupancy durations for the channel included in the multiple SCIs, wherein the source ID associated with the received multiple remaining channel occupancy durations are the same, and the CO-sharing ID associated with the remaining channel occupancy durations at least includes the UE.

In yet another instance, the UE determines the combined remaining channel occupancy duration for a channel as the maximum of remaining channel occupancy duration determined based on the received multiple remaining channel occupancy durations for the channel included in the multiple SCIs, wherein the source ID associated with the received multiple remaining channel occupancy durations are the same, and the CO-sharing ID associated with the remaining channel occupancy durations at least includes the UE.

In yet another instance, the UE determines the combined remaining channel occupancy duration for a channel as the minimum of remaining channel occupancy duration determined based on the received multiple remaining channel occupancy durations for the channel included in the multiple SCIs, wherein the source ID associated the received multiple the remaining channel occupancy durations are the same, and the CO-sharing ID associated with the remaining channel occupancy durations at least includes the UE, and the cast type included in and/or associated with the multiple SCIs are the same.

In yet another instance, the UE determines the combined remaining channel occupancy duration for a channel as the maximum of remaining channel occupancy duration determined based on the received multiple remaining channel occupancy durations for the channel included in the multiple SCIs, wherein the source ID associated with the received multiple remaining channel occupancy durations are the same, and the CO-sharing ID associated with the remaining channel occupancy durations at least includes the UE, and the cast type included in and/or associated with the multiple SCIs are the same.

In yet another instance, the UE determines the combined remaining channel occupancy duration for a channel as the minimum of remaining channel occupancy duration determined based on the received multiple remaining channel occupancy durations for the channel included in the multiple SCIs, wherein the source ID associated with the received multiple remaining channel occupancy durations are the same, and the cast type included in and/or associated with the multiple SCIs are the same.

In yet another instance, the UE determines the combined remaining channel occupancy duration for a channel as the maximum of remaining channel occupancy duration determined based on the received multiple remaining channel occupancy durations for the channel included in the multiple SCIs, wherein the source ID associated with the received multiple remaining channel occupancy durations are the same, and the cast type included in and/or associated with the multiple SCIs are the same.

In one embodiment, if a UE is performing SL transmission on a channel with a first remaining channel occupancy duration, and received a SCI including a second remaining channel occupancy duration for the channel, the UE can determine the updated time domain information on the channel occupancy based on the first and second remaining channel occupancy durations.

In one instance, the UE determines the updated remaining channel occupancy duration for the channel as the minimum value of the first and second remaining channel occupancy durations.

In another instance, the UE determines the updated remaining channel occupancy duration for the channel as the maximum value of the first and second remaining channel occupancy durations.

In yet another instance, the UE determines the updated remaining channel occupancy duration for the channel as the minimum value of the first and second remaining channel occupancy durations, if the source ID associated with the second remaining channel occupancy duration is the same as the source ID associated with the first remaining channel occupancy duration.

In yet another instance, the UE determines the updated remaining channel occupancy duration for the channel as the maximum value of the first and second remaining channel occupancy durations, if the source ID associated with the second remaining channel occupancy duration is the same as the source ID associated with the first remaining channel occupancy duration.

In yet another instance, the UE determines the updated remaining channel occupancy duration for the channel as the minimum value of the first and second remaining channel occupancy durations, if the source ID associated with the second remaining channel occupancy duration is the same as the source ID associated with the first remaining channel occupancy duration, and the CO-sharing ID associated with the second remaining channel occupancy durations at least includes the UE.

In yet another instance, the UE determines the updated remaining channel occupancy duration for the channel as the maximum value of the first and second remaining channel occupancy durations, if the source ID associated with the second remaining channel occupancy duration is the same as the source ID associated with the first remaining channel occupancy duration, and the CO-sharing ID associated with the second remaining channel occupancy durations at least includes the UE.

In yet another instance, the UE determines the updated remaining channel occupancy duration for the channel as the minimum value of the first and second remaining channel occupancy durations, if the source ID associated with the second remaining channel occupancy duration is the same as the source ID associated with the first remaining channel occupancy duration, and the CO-sharing ID associated with the second remaining channel occupancy durations at least includes the UE, and the cast type of the SL transmission being performed by the UE and cast type of the SL transmission received by the UE are the same.

In yet another instance, the UE determines the updated remaining channel occupancy duration for the channel as the maximum value of the first and second remaining channel occupancy durations, if the source ID associated with the second remaining channel occupancy duration is the same as the source ID associated with the first remaining channel occupancy duration, and the CO-sharing ID associated with the second remaining channel occupancy durations at least includes the UE, and the cast type of the SL transmission being performed by the UE and cast type of the SL transmission received by the UE are the same.

In yet another instance, the UE determines the updated remaining channel occupancy duration for the channel as the minimum value of the first and second remaining channel occupancy durations, if the source ID associated with the second remaining channel occupancy duration is the same as the source ID associated with the first remaining channel occupancy duration, and the cast type of the SL transmission being performed by the UE and cast type of the SL transmission received by the UE are the same.

In yet another instance, the UE determines the updated remaining channel occupancy duration for the channel as the maximum value of the first and second remaining channel occupancy durations, if the source ID associated with the second remaining channel occupancy duration is the same as the source ID associated with the first remaining channel occupancy duration, and the cast type of the SL transmission being performed by the UE and cast type of the SL transmission received by the UE are the same.

In one embodiment, the time domain information on the channel occupancy can be utilized for validation of SL transmissions.

In one instance, a UE does not expect to receive any SL transmission outside the duration (e.g., remaining channel occupancy) determined by the time domain information on the channel occupancy.

In another instance, a UE expects SL signal(s)/channel(s) to be transmitted (e.g., scheduled to be transmitted or configured to be transmitted) within the duration (e.g., remaining channel occupancy) determined by the time domain information on the channel occupancy are actually transmitted.

In yet another instance, if a UE is provided with multiple candidate locations in time domain to receive SL signal(s)/channel(s), and also provided with the time domain information on the channel occupancy, the UE expects the SL signal(s)/channel(s) is actually transmitted in at least one of the multiple candidate locations in time domain confined within the duration (e.g., remaining channel occupancy) determined by the time domain information on the channel occupancy.

In yet another instance, if a UE is provided with multiple candidate locations in time domain to receive SL signal(s)/channel(s), and also provided with the time domain information on the channel occupancy, the UE does not expect the SL signal(s)/channel(s) is actually transmitted in any candidate location in time domain outside the duration (e.g., remaining channel occupancy) determined by the time domain information on the channel occupancy.

In one embodiment, the time domain information on the channel occupancy can be utilized for resource selection on sidelink.

In one instance, when a UE receives a SCI including the information on reserved resource for SL transmission, the UE assumes such reserved resource can be used for actual transmission if the actual transmission is within the duration of the channel occupancy provided by the time domain information on the channel occupancy.

In another instance, when a UE receives a SCI including the information on reserved resource for transmission, the UE assumes such reserved resource may not be used for actual transmission if the actual transmission is outside the duration of the channel occupancy provided by the time domain information on the channel occupancy, and the UE can reserve such resource for its own transmission.

In yet another instance, when a UE receives a SCI including the information on reserved resource for transmission, the UE may need to perform channel access procedure in order to determine whether a reserved resource is available to be used for transmission if the transmission is outside the duration of the channel occupancy provided by the time domain information on the channel occupancy.

In one embodiment, the indication of the time domain information on channel occupancy can be forwarded.

In one example, when the SCI corresponds to groupcast SL transmission or broadcast SL transmission, any UE in the group for groupcast SL transmission or as a receiver of the broadcast SL transmission can receive the SCI, update the time domain information on the channel occupancy, and transmit such information in another SCI in the channel occupancy.

In another example, when the SCI corresponds to groupcast SL transmission or broadcast SL transmission, only one UE in the group (e.g., the groupcast leader) for groupcast SL transmission or only one UE (e.g., leader) for broadcast SL transmission can update the time domain information on the channel occupancy, and transmit such information in a SCI in the channel occupancy.

In yet another example, when the SCI corresponds to unicast SL transmission, either of the UEs in the unicast SL transmission can receive the SCI, update the time domain information on the channel occupancy, and transmit such information in another SCI in the channel occupancy.

In yet another example, when the SCI corresponds to unicast SL transmission, only one UE in the group (e.g., the UE initializing the channel occupancy) for unicast SL transmission can update the time domain information on the channel occupancy, and transmit such information in a SCI in the channel occupancy.

In one embodiment, an indication of frequency domain information on channel occupancy can be included in an SCI format.

In one example, the frequency domain information can be a bitmap, wherein each bit corresponds to an RB-set. For instance, the bit taking value of 1 indicates the corresponding RB-set can be available for SL transmission and/or reception. For another instance, the bit taking value of 0 indicates the corresponding RB-set may not be available for SL transmission and/or reception.

In another example, the frequency domain information can be an indication of sub-channel-sets available for SL transmission, e.g., using a bitmap and each bit corresponding to a sub-channel-set.

In one embodiment, the frequency domain information on the channel occupancy can be associated with a source ID (e.g., an ID associated with a source transmitter UE).

For one instance, when a UE receives a SCI format (e.g., SCI format 2-A and/or format 2-B and/or format 2-C), the frequency domain information on the channel occupancy can be associated with a source ID given by the “source ID” field as included in the SCI format. A UE that receives the frequency domain information on the channel occupancy can determine such frequency domain information is applicable for the channel occupancy utilized for SL transmission from the transmitter UE with the identity provided by the “source ID” field.

For another instance, when a UE receives a SCI format, the frequency domain information on the channel occupancy can be associated with a source ID field as included in the same SCI format that includes the frequency domain information. A UE that receives the frequency domain information on the channel occupancy can determine such frequency domain information is applicable for the channel occupancy utilized for SL transmission from the transmitter with the identity provided by the source ID field included in the same SCI format that includes the frequency domain information.

For yet another instance, when a UE receives a SCI format, the frequency domain information on the channel occupancy can be associated with a source ID included in a RNTI that scrambles the SCI format. A UE that receives the frequency domain information on the channel occupancy can determine such frequency domain information is applicable for the channel occupancy utilized for SL transmission from the transmitter with the identity provided by the source ID included in the RNTI. In one aspect, the SCI format can be included in the PSCCH. In another aspect, the SCI format can be included in the PSSCH.

For yet another instance, when a UE initiates a channel occupancy by completing a channel access procedure, the source ID associated with the frequency domain information on the channel occupancy is the UE itself (e.g., the source ID is associated with the UE initiates the channel occupancy).

For yet another instance, the source ID associated with the frequency domain information on the channel occupancy may not have to refer to the transmitter of the transmission including the SCI. For a sub-instance, the source ID associated with the frequency domain information on the channel occupancy can refer to a first UE (e.g., the UE initializing the channel occupancy), and the SCI including the frequency domain information on the channel occupancy can be transmitted from a second UE to a third UE, wherein the second UE uses the shared channel occupancy from the first UE and performs sidelink transmission to the third UE.

In another embodiment, the frequency domain information on the channel occupancy can be associated with a CO-sharing ID.

For one instance, when a UE receives a SCI format (e.g., SCI format 2-A and/or format 2-B and/or format 2-C), the frequency domain information on the channel occupancy can be associated with the “destination ID” field as included in the SCI format(e.g., the CO-sharing ID can be represented by the “destination ID”). A UE that receives the frequency domain information on the channel occupancy can determine such frequency domain information is applicable for the channel occupancy utilized for SL transmission to the receiver(s) with the identity provided by the “destination ID” field.

For another instance, when a UE receives a SCI format, the frequency domain information on the channel occupancy can be associated with a CO-sharing ID field as included in the same SCI format that includes the frequency domain information (e.g., the CO-sharing ID field may be different from “destination ID” field). A UE that receives the frequency domain information on the channel occupancy can determine such frequency domain information is applicable for the channel occupancy utilized for SL transmission to the receiver(s) with the identity provided by the CO-sharing ID field included in the same SCI format that includes the frequency domain information.

For yet another instance, when a UE receives a SCI format, the frequency domain information on the channel occupancy can be associated with a CO-sharing ID included in a RNTI that scrambles the SCI format. A UE that receives the frequency domain information on the channel occupancy can determine such frequency domain information is applicable for the channel occupancy utilized for SL transmission to the receiver(s) with the identity provided by CO-sharing ID. In one aspect, the SCI format can be included in the PSCCH. In another aspect, the SCI format can be included in the PSSCH.

For yet another instance, when a UE initializes a channel occupancy by performing a channel access procedure, the CO-sharing ID associated with the frequency domain information on the channel occupancy is the one or more UEs as the receiver(s) of the SL transmissions performed by the UE.

In yet another embodiment, a UE that receives the frequency domain information on the channel occupancy can further share the channel occupancy to start a new SL transmission over the available RB-set(s), if a condition on at least one ID is satisfied.

For one instance, the UE that receives the frequency domain information on the channel occupancy can further share the channel occupancy to start a new SL transmission over the available RB-set(s), if the CO-sharing ID associated with the channel occupancy (e.g., according to the instance of this disclosure) corresponds to the UE or includes the UE.

For another instance, the UE that receives the frequency domain information on the channel occupancy can further share the channel occupancy to start a new SL transmission over the available RB-set(s), if the CO-sharing ID associated with the channel occupancy corresponds to the UE (e.g., according to the instance of this disclosure) corresponds to the UE or includes the UE, and/or the source ID associated with the channel occupancy corresponds to or is included in the receiver(s) of the new SL transmission.

For one instance, the UE that receives the frequency domain information on the channel occupancy can further share the channel occupancy to start a new SL transmission over the available sub-channel-set(s), if the CO-sharing ID associated with the channel occupancy (e.g., according to the instance of this disclosure) corresponds to the UE or includes the UE.

For another instance, the UE that receives the frequency domain information on the channel occupancy can further share the channel occupancy to start a new SL transmission over the available sub-channel-set(s), if the CO-sharing ID associated with the channel occupancy corresponds to the UE (e.g., according to the instance of this disclosure) corresponds to the UE or includes the UE, and/or the source ID associated with the channel occupancy corresponds to or is included in the receiver(s) of the new SL transmission.

In yet another embodiment, a UE can receive multiple frequency domain information on the channel occupancy included in multiple SCIs at the same time, and determine a combined frequency domain information on the channel occupancy based on multiple received frequency domain information on the channel occupancy.

In one instance, the UE determines the combined available RB-set for a channel as the intersection of the received multiple available RB-sets for the channel included in the multiple SCIs.

In another instance, the UE determines the combined available RB-set for a channel as the union of the received multiple available RB-sets for the channel included in the multiple SCIs.

In yet another instance, the UE determines the combined available RB-set for a channel as the intersection of the received multiple available RB-sets for the channel included in the multiple SCIs, wherein the source ID associated with the received multiple available RB-sets are the same.

In yet another instance, the UE determines the combined available RB-set for a channel as the union of the received multiple available RB-sets for the channel included in the multiple SCIs, wherein the source ID associated with the received multiple available RB-sets are the same.

In yet another instance, the UE determines the combined available RB-set for a channel as the intersection of the received multiple available RB-sets for the channel included in the multiple SCIs, wherein the source ID associated with the received multiple available RB-sets are the same, and the CO-sharing ID associated with the available RB-sets at least includes the UE.

In yet another instance, the UE determines the combined available RB-set for a channel as the union of the received multiple available RB-sets for the channel included in the multiple SCIs, wherein the source ID associated with the received multiple available RB-sets are the same, and the CO-sharing ID associated with the available RB-sets at least includes the UE.

In yet another instance, the UE determines the combined available RB-set for a channel as the intersection of the received multiple available RB-sets for the channel included in the multiple SCIs, wherein the source ID associated the received multiple the available RB-sets are the same, and the CO-sharing ID associated with the available RB-sets at least includes the UE, and the cast type included in and/or associated with the multiple SCIs are the same.

In yet another instance, the UE determines the combined available RB-set for a channel as the union of the received multiple available RB-sets for the channel included in the multiple SCIs, wherein the source ID associated with the received multiple available RB-sets are the same, and the CO-sharing ID associated with the available RB-sets at least includes the UE, and the cast type included in and/or associated with the multiple SCIs are the same.

In yet another instance, the UE determines the combined available RB-set for a channel as the intersection of the received multiple available RB-sets for the channel included in the multiple SCIs, wherein the source ID associated with the received multiple available RB-sets are the same, and the cast type included in and/or associated with the multiple SCIs are the same.

In yet another instance, the UE determines the combined available RB-set for a channel as the union of the received multiple available RB-sets for the channel included in the multiple SCIs, wherein the source ID associated with the received multiple available RB-sets are the same, and the cast type included in and/or associated with the multiple SCIs are the same.

In one instance, the UE determines the combined available sub-channel-set for a channel as the intersection of the received multiple available sub-channel-sets for the channel included in the multiple SCIs.

In another instance, the UE determines the combined available sub-channel-set for a channel as the union of the received multiple available sub-channel-sets for the channel included in the multiple SCIs.

In yet another instance, the UE determines the combined available sub-channel-set for a channel as the intersection of the received multiple available sub-channel-sets for the channel included in the multiple SCIs, wherein the source ID associated with the received multiple available sub-channel-sets are the same.

In yet another instance, the UE determines the combined available sub-channel-set for a channel as the union of the received multiple available sub-channel-sets for the channel included in the multiple SCIs, wherein the source ID associated with the received multiple available sub-channel-sets are the same.

In yet another instance, the UE determines the combined available sub-channel-set for a channel as the intersection of the received multiple available sub-channel-sets for the channel included in the multiple SCIs, wherein the source ID associated with the received multiple available sub-channel-sets are the same, and the CO-sharing ID associated with the available sub-channel-sets at least includes the UE.

In yet another instance, the UE determines the combined available sub-channel-set for a channel as the union of the received multiple available sub-channel-sets for the channel included in the multiple SCIs, wherein the source ID associated with the received multiple available sub-channel-sets are the same, and the CO-sharing ID associated with the available sub-channel-sets at least includes the UE.

In yet another instance, the UE determines the combined available sub-channel-set for a channel as the intersection of the received multiple available sub-channel-sets for the channel included in the multiple SCIs, wherein the source ID associated the received multiple the available sub-channel-sets are the same, and the CO-sharing ID associated with the available sub-channel-sets at least includes the UE, and the cast type included in and/or associated with the multiple SCIs are the same.

In yet another instance, the UE determines the combined available sub-channel-set for a channel as the union of the received multiple available sub-channel-sets for the channel included in the multiple SCIs, wherein the source ID associated with the received multiple available sub-channel-sets are the same, and the CO-sharing ID associated with the available sub-channel-sets at least includes the UE, and the cast type included in and/or associated with the multiple SCIs are the same.

In yet another instance, the UE determines the combined available sub-channel-set for a channel as the intersection of the received multiple available sub-channel-sets for the channel included in the multiple SCIs, wherein the source ID associated with the received multiple available sub-channel-sets are the same, and the cast type included in and/or associated with the multiple SCIs are the same.

In yet another instance, the UE determines the combined available sub-channel-set for a channel as the union of the received multiple available sub-channel-sets for the channel included in the multiple SCIs, wherein the source ID associated with the received multiple available sub-channel-sets are the same, and the cast type included in and/or associated with the multiple SCIs are the same.

In yet another embodiment, if a UE is performing SL transmission on a channel with a first available RB-set, and received a SCI including a second available RB-set for the channel, the UE can determine the updated frequency domain information on the channel occupancy based on the first and second available RB-sets.

In one instance, the UE determines the updated available RB-set for the channel as the intersection of the first and second available RB-sets.

In another instance, the UE determines the updated available RB-set for the channel as the union of the first and second available RB-sets.

In yet another instance, the UE determines the updated available RB-set for the channel as the intersection of the first and second available RB-sets, if the source ID associated with the second available RB-set is the same as the source ID associated with the first available RB-set.

In yet another instance, the UE determines the updated available RB-set for the channel as the union of the first and second available RB-sets, if the source ID associated with the second available RB-set is the same as the source ID associated with the first available RB-set.

In yet another instance, the UE determines the updated available RB-set for the channel as the intersection of the first and second available RB-sets, if the source ID associated with the second available RB-set is the same as the source ID associated with the first available RB-set, and the CO-sharing ID associated with the second available RB-sets at least includes the UE.

In yet another instance, the UE determines the updated available RB-set for the channel as the union of the first and second available RB-sets, if the source ID associated with the second available RB-set is the same as the source ID associated with the first available RB-set, and the CO-sharing ID associated with the second available RB-sets at least includes the UE.

In yet another instance, the UE determines the updated available RB-set for the channel as the intersection of the first and second available RB-sets, if the source ID associated with the second available RB-set is the same as the source ID associated with the first available RB-set, and the CO-sharing ID associated with the second available RB-sets at least includes the UE, and the cast type of the SL transmission being performed by the UE and cast type of the SL transmission received by the UE are the same.

In yet another instance, the UE determines the updated available RB-set for the channel as the union of the first and second available RB-sets, if the source ID associated with the second available RB-set is the same as the source ID associated with the first available RB-set, and the CO-sharing ID associated with the second available RB-sets at least includes the UE, and the cast type of the SL transmission being performed by the UE and cast type of the SL transmission received by the UE are the same.

In yet another instance, the UE determines the updated available RB-set for the channel as the intersection of the first and second available RB-sets, if the source ID associated with the second available RB-set is the same as the source ID associated with the first available RB-set, and the cast type of the SL transmission being performed by the UE and cast type of the SL transmission received by the UE are the same.

In yet another instance, the UE determines the updated available RB-set for the channel as the union of the first and second available RB-sets, if the source ID associated with the second available RB-set is the same as the source ID associated with the first available RB-set, and the cast type of the SL transmission being performed by the UE and cast type of the SL transmission received by the UE are the same.

In one instance, the UE determines the updated available sub-channel-set for the channel as the intersection of the first and second available sub-channel-sets.

In another instance, the UE determines the updated available sub-channel-set for the channel as the union of the first and second available sub-channel-sets.

In yet another instance, the UE determines the updated available sub-channel-set for the channel as the intersection of the first and second available sub-channel-sets, if the source ID associated with the second available sub-channel-set is the same as the source ID associated with the first available sub-channel-set.

In yet another instance, the UE determines the updated available sub-channel-set for the channel as the union of the first and second available sub-channel-sets, if the source ID associated with the second available sub-channel-set is the same as the source ID associated with the first available sub-channel-set.

In yet another instance, the UE determines the updated available sub-channel-set for the channel as the intersection of the first and second available sub-channel-sets, if the source ID associated with the second available sub-channel-set is the same as the source ID associated with the first available sub-channel-set, and the CO-sharing ID associated with the second available sub-channel-sets at least includes the UE.

In yet another instance, the UE determines the updated available sub-channel-set for the channel as the union of the first and second available sub-channel-sets, if the source ID associated with the second available sub-channel-set is the same as the source ID associated with the first available sub-channel-set, and the CO-sharing ID associated with the second available sub-channel-sets at least includes the UE.

In yet another instance, the UE determines the updated available sub-channel-set for the channel as the intersection of the first and second available sub-channel-sets, if the source ID associated with the second available sub-channel-set is the same as the source ID associated with the first available sub-channel-set, and the CO-sharing ID associated with the second available sub-channel-sets at least includes the UE, and the cast type of the SL transmission being performed by the UE and cast type of the SL transmission received by the UE are the same.

In yet another instance, the UE determines the updated available sub-channel-set for the channel as the union of the first and second available sub-channel-sets, if the source ID associated with the second available sub-channel-set is the same as the source ID associated with the first available sub-channel-set, and the CO-sharing ID associated with the second available sub-channel-sets at least includes the UE, and the cast type of the SL transmission being performed by the UE and cast type of the SL transmission received by the UE are the same.

In yet another instance, the UE determines the updated available sub-channel-set for the channel as the intersection of the first and second available sub-channel-sets, if the source ID associated with the second available sub-channel-set is the same as the source ID associated with the first available sub-channel-set, and the cast type of the SL transmission being performed by the UE and cast type of the SL transmission received by the UE are the same.

In yet another instance, the UE determines the updated available sub-channel-set for the channel as the union of the first and second available sub-channel-sets, if the source ID associated with the second available sub-channel-set is the same as the source ID associated with the first available sub-channel-set, and the cast type of the SL transmission being performed by the UE and cast type of the SL transmission received by the UE are the same.

In yet another embodiment, the frequency domain information on the channel occupancy can be utilized for validation of SL transmissions.

In one instance, a UE does not expect to receive any SL transmission over RB-set(s) other than the available RB-set(s) determined by the frequency domain information on the channel occupancy.

In another instance, a UE expects SL signal(s)/channel(s) to be transmitted (e.g., scheduled to be transmitted or configured to be transmitted) over the available RB-set(s) determined by the frequency domain information on the channel occupancy are actually transmitted.

In yet another instance, if a UE is provided with multiple candidate locations in frequency domain to receive SL signal(s)/channel(s), and also provided with the frequency domain information on the channel occupancy, the UE expects the SL signal(s)/channel(s) is actually transmitted in at least one of the multiple candidate locations in frequency domain confined within the available RB-set(s) determined by the frequency domain information on the channel occupancy.

In yet another instance, if a UE is provided with multiple candidate locations in frequency domain to receive SL signal(s)/channel(s), and also provided with the frequency domain information on the channel occupancy, the UE does not expect the SL signal(s)/channel(s) is actually transmitted in any candidate location in frequency domain over RB-set(s) other than the available RB-set(s) determined by the frequency domain information on the channel occupancy.

In one instance, a UE does not expect to receive any SL transmission over sub-channel-set(s) other than the available sub-channel-set(s) determined by the frequency domain information on the channel occupancy.

In another instance, a UE expects SL signal(s)/channel(s) to be transmitted (e.g., scheduled to be transmitted or configured to be transmitted) over the available sub-channel-set(s) determined by the frequency domain information on the channel occupancy are actually transmitted.

In yet another instance, if a UE is provided with multiple candidate locations in frequency domain to receive SL signal(s)/channel(s), and also provided with the frequency domain information on the channel occupancy, the UE expects the SL signal(s)/channel(s) is actually transmitted in at least one of the multiple candidate locations in frequency domain confined within the available sub-channel-set(s) determined by the frequency domain information on the channel occupancy.

In yet another instance, if a UE is provided with multiple candidate locations in frequency domain to receive SL signal(s)/channel(s), and also provided with the frequency domain information on the channel occupancy, the UE does not expect the SL signal(s)/channel(s) is actually transmitted in any candidate location in frequency domain over sub-channel-set(s) other than the available sub-channel-set(s) determined by the frequency domain information on the channel occupancy.

In yet another embodiment, the frequency domain information on the channel occupancy can be utilized for resource selection on a sidelink.

In one instance, when a UE receives a SCI including the information on reserved resource for SL transmission, the UE assumes such reserved resource can be used for actual transmission if the resource is within the available RB-set(s) provided by the frequency domain information on the channel occupancy.

In another instance, when a UE receives a SCI including the information on reserved resource for transmission, the UE assumes such reserved resource may not be used for actual transmission if the resource is outside the available RB-set(s) provided by the frequency domain information on the channel occupancy, and the UE can reserve such resource for its own transmission.

In one instance, when a UE receives a SCI including the information on reserved resource for SL transmission, the UE assumes such reserved resource can be used for actual transmission if the resource is within the available sub-channel-set(s) provided by the frequency domain information on the channel occupancy.

In another instance, when a UE receives a SCI including the information on reserved resource for transmission, the UE assumes such reserved resource may not be used for actual transmission if the resource is outside the available sub-channel-set(s) provided by the frequency domain information on the channel occupancy, and the UE can reserve such resource for its own transmission.

In one embodiment, the indication of the frequency domain information on channel occupancy can be forwarded.

In one example, when the SCI corresponds to groupcast SL transmission or broadcast SL transmission, any UE in the group for groupcast SL transmission or as a receiver of the broadcast SL transmission can receive the SCI, update the frequency domain information on the channel occupancy, and transmit such information in another SCI in the channel occupancy.

In another example, when the SCI corresponds to groupcast SL transmission or broadcast SL transmission, only one UE in the group (e.g., the groupcast leader) for groupcast SL transmission or only one UE (e.g., leader) for broadcast SL transmission can update the frequency domain information on the channel occupancy, and transmit such information in a SCI in the channel occupancy.

In yet another example, when the SCI corresponds to unicast SL transmission, either of the UEs in the unicast SL transmission can receive the SCI, update the frequency domain information on the channel occupancy, and transmit such information in another SCI in the channel occupancy.

In yet another example, when the SCI corresponds to unicast SL transmission, only one UE in the group (e.g., the UE initializing the channel occupancy) for unicast SL transmission can update the frequency domain information on the channel occupancy, and transmit such information in a SCI in the channel occupancy.

In one embodiment, an indication of at least one configuration on the PSCCH can be included in a SCI format.

For one example, N≥1 sets of configurations on the PSCCH can be provided by pre-configuration and/or configuration from higher layer parameters and/or fixed in the specification, and an indication of the index of the set of configurations can be included in the SCI format. A UE receives the PSCCH according to the set of configurations on PSCCH indicated by the SCI format. For one sub-example, N=2, and one bit in the SCI format can be used to indicate one of the two sets of configurations on the PSCCH.

For one instance, the set of configurations on the PSCCH at least includes the index(es) of starting symbol(s) for PSCCH (e.g., or in general for SL transmissions and the starting symbol for PSCCH is determined based on the starting symbol for SL transmissions).

For another instance, the set of configurations on the PSCCH at least includes a number of symbols for PSCCH.

For yet another instance, the set of configurations on the PSCCH at least includes a number of locations to monitor for receiving PSCCH.

For another example, an indication of the index(es) of starting symbol(s) for PSCCH can be included in the SCI format. A UE receives the PSCCH according to the index(es) of starting symbol(s) for PSCCH indicated by the SCI format.

For yet another example, an indication of a number of symbols for PSCCH can be included in the SCI format. A UE receives the PSCCH according to the number of symbols for PSCCH indicated by the SCI format.

For yet another example, an indication of a number of locations to monitor for receiving PSCCH can be included in the SCI format. A UE receives the PSCCH according to the number of locations to monitor for receiving PSCCH indicated by the SCI format.

In one embodiment, the PSCCH configuration can be associated with a source ID.

For one instance, when a UE receives a SCI format (e.g., SCI format 2-A and/or format 2-B and/or format 2-C), the PSCCH configuration can be associated with a source ID given by the “source ID” field as included in the SCI format.

For another instance, when a UE receives a SCI format, the PSCCH configuration can be associated with a source ID field as included in the same SCI format that includes the frequency domain information.

For yet another instance, when a UE receives a SCI format, the PSCCH configuration can be associated with a source ID included in a RNTI that scrambles the SCI format. In one aspect, the SCI format can be included in the PSCCH. In another aspect, the SCI format can be included in the PSSCH.

For yet another instance, the source ID associated with the PSCCH configuration may not have to refer to the transmitter of the transmission including the SCI. For a sub-instance, the source ID associated with the PSCCH configuration can refer to a first UE (e.g., the UE initializing the channel occupancy), and the SCI including the PSCCH configuration can be transmitted from a second UE to a third UE, wherein the second UE uses the shared channel occupancy from the first UE and perform sidelink transmission to the third UE.

In another embodiment, the PSCCH configuration can be associated with a CO-sharing ID.

For one instance, when a UE receives a SCI format (e.g., SCI format 2-A and/or format 2-B and/or format 2-C), the PSCCH configuration can be associated with a CO-sharing ID given by the “destination ID” field as included in the SCI format 2-A and/or format 2-B.

For another instance, when a UE receives a SCI format, the PSCCH configuration can be associated with a CO-sharing ID field as included in the same SCI format that includes the frequency domain information (e.g., the CO-sharing ID field may be different from “destination ID” field).

For yet another instance, when a UE receives a SCI format, the PSCCH configuration can be associated with a CO-sharing ID included in a RNTI that scrambles the SCI format. In one aspect, the SCI format can be included in the PSCCH. In another aspect, the SCI format can be included in the PSSCH.

In yet another embodiment, a UE that receives the PSCCH configuration can receive the PSCCH according to the PSCCH configuration, if a condition on at least one ID is satisfied.

For one instance, the UE receives the PSCCH according to the PSCCH configuration, if the CO-sharing ID associated with the PSCCH configuration (e.g., according to the instance of this disclosure) corresponds to the UE or includes the UE.

In yet another embodiment, there can be a delay (e.g., denoted as P_{switch,SL}) for a UE receiving the SCI including the PSCCH configuration to switch from the previous PSCCH configuration to the new PSCCH configuration. In one instance, the delay (e.g., P_{switch,SL}) can be determined based on a SCS associated with the SL resource pool. In another instance, the delay (e.g., P_{switch,SL}) can correspond to the same absolute time duration for at least two of the SCSs supported for the SL resource pool, e.g., the number of symbols/slots scale reciprocally with the SCS.

In one embodiment, the indication of PSCCH configuration can be forwarded.

In one example, when the SCI corresponds to groupcast SL transmission or broadcast SL transmission, any UE in the group for groupcast SL transmission or as a receiver of the broadcast SL transmission can receive the SCI, update the PSCCH configuration, and transmit the PSCCH configuration in another SCI in the channel occupancy.

In another example, when the SCI corresponds to groupcast SL transmission or broadcast SL transmission, only one UE in the group (e.g., the groupcast leader) for groupcast SL transmission or only one UE (e.g., leader) for broadcast SL transmission can update the PSCCH configuration, and transmit the PSCCH configuration in a SCI in the channel occupancy.

In yet another example, when the SCI corresponds to unicast SL transmission, either of the UEs in the unicast SL transmission can receive the SCI, update the PSCCH configuration, and transmit the PSCCH configuration in another SCI in the channel occupancy.

In yet another example, when the SCI corresponds to unicast SL transmission, only one UE in the group (e.g., the UE initializing the channel occupancy) for unicast SL transmission can update the PSCCH configuration, and transmit the PSCCH configuration in a SCI in the channel occupancy.

In one embodiment, at least one of the time domain channel occupancy, frequency domain channel occupancy, or PSCCH configuration indications can be included in a SCI format.

In one example, the following information is transmitted by means of the SCI format 1-A: time domain channel occupancy 1, time domain channel occupancy 2, . . . , time domain channel occupancy N1.

In another example, the following information is transmitted by means of the SCI format 2-A: time domain channel occupancy 1, time domain channel occupancy 2, . . . , time domain channel occupancy N1.

In yet another example, the following information is transmitted by means of the SCI format 2-B: time domain channel occupancy 1, time domain channel occupancy 2, . . . , time domain channel occupancy N1.

In yet another example, the following information is transmitted by means of a new SCI format (e.g., a SCI format other than 1-A, 2-A, and 2-B): (1) a source ID; and (2) time domain channel occupancy 1, time domain channel occupancy 2, . . . , time domain channel occupancy N1.

In yet another example, the following information is transmitted by means of a new SCI format (e.g., a SCI format other than 1-A, 2-A, and 2-B): (1) a source ID, (2) a CO-sharing ID, and (3) time domain channel occupancy 1, time domain channel occupancy 2, . . . , time domain channel occupancy N1.

In yet another example, the following information is transmitted by means of a new SCI format (e.g., a SCI format other than 1-A, 2-A, and 2-B): (1) a CO-sharing ID and (2) time domain channel occupancy 1, time domain channel occupancy 2, . . . , time domain channel occupancy N1.

In yet another example, the following information is transmitted by means of a new SCI format (e.g., a SCI format other than 1-A, 2-A, and 2-B) with CRC scrambled by a new sidelink RNTI (wherein the new sidelink RNTI can be generated based on at least one of the source ID or the CO-sharing ID): time domain channel occupancy 1, time domain channel occupancy 2, . . . , time domain channel occupancy N1.

In one embodiment, in the examples of this disclosure, the “time domain channel occupancy 1,” “time domain channel occupancy 2,” . . . , “time domain channel occupancy N1” included in the SCI format can be further subject to a higher layer parameter being configured, and the value of N1 can be determined based on the higher layer parameter.

In another embodiment, in the examples of this disclosure, N1 can be fixed in the specification and/or pre-configured, e.g., N1=1.

In one example, the following information is transmitted by means of the SCI format 1-A: (1) frequency domain channel occupancy 1, frequency domain channel occupancy 2, . . . , frequency domain channel occupancy N2.

In another example, the following information is transmitted by means of the SCI format 2-A: frequency domain channel occupancy 1, frequency domain channel occupancy 2, . . . , frequency domain channel occupancy N2.

In yet another example, the following information is transmitted by means of the SCI format 2-B: frequency domain channel occupancy 1, frequency domain channel occupancy 2, . . . , frequency domain channel occupancy N2.

In yet another example, the following information is transmitted by means of a new SCI format (e.g., a SCI format other than 1-A, 2-A, and 2-B): (1) a source ID and (2) frequency domain channel occupancy 1, frequency domain channel occupancy 2, . . . , frequency domain channel occupancy N2.

In yet another example, the following information is transmitted by means of a new SCI format (e.g., a SCI format other than 1-A, 2-A, and 2-B): (1) source ID, (2) CO-sharing ID, and (3) frequency domain channel occupancy 1, frequency domain channel occupancy 2, . . . , frequency domain channel occupancy N2.

In yet another example, the following information is transmitted by means of a new SCI format (e.g., a SCI format other than 1-A, 2-A, and 2-B): (1) CO-sharing ID and (2) frequency domain channel occupancy 1, frequency domain channel occupancy 2, . . . , frequency domain channel occupancy N2.

In yet another example, the following information is transmitted by means of a new SCI format (e.g., a SCI format other than 1-A, 2-A, and 2-B) with CRC scrambled by a new sidelink RNTI (wherein the new sidelink RNTI can be generated based on at least one of the source ID or the CO-sharing ID): frequency domain channel occupancy 1, frequency domain channel occupancy 2, . . . , frequency domain channel occupancy N2.

In one embodiment, in the examples of this disclosure, the “frequency domain channel occupancy 1,” “frequency domain channel occupancy 2,” . . . , “frequency domain channel occupancy N2” included in the SCI format can be further subject to a higher layer parameter being configured, and the value of N2 can be determined based on the higher layer parameter.

In another embodiment, in the examples of this disclosure, N2 can be fixed in the specification and/or pre-configured, e.g., N2=1.

In one example, the following information is transmitted by means of the SCI format 1-A: a PSCCH configuration 1, a PSCCH configuration 2, . . . , a PSCCH configuration N3.

In another example, the following information is transmitted by means of the SCI format 2-A: a PSCCH configuration 1, a PSCCH configuration 2, . . . , a PSCCH configuration N3.

In yet another example, the following information is transmitted by means of the SCI format 2-B: a PSCCH configuration 1, a PSCCH configuration 2, . . . , a PSCCH configuration N3.

In yet another example, the following information is transmitted by means of a new SCI format (e.g., a SCI format other than 1-A, 2-A, and 2-B, 2-C): (1) a source ID and (2) a PSCCH configuration 1, a PSCCH configuration 2, . . . , a PSCCH configuration N3.

In yet another example, the following information is transmitted by means of a new SCI format (e.g., a SCI format other than 1-A, 2-A, and 2-B, 2-C): (1) a source ID, (2) a CO-sharing ID, and (3) a PSCCH configuration 1, a PSCCH configuration 2, . . . , a PSCCH configuration N3.

In yet another example, the following information is transmitted by means of a new SCI format (e.g., a SCI format other than 1-A, 2-A, and 2-B, 2-C): (1) a CO-sharing ID and (2) a PSCCH configuration 1, a PSCCH configuration 2, . . . , a PSCCH configuration N3.

In yet another example, the following information is transmitted by means of a new SCI format (e.g., a SCI format other than 1-A, 2-A, and 2-B, 2-C) with CRC scrambled by a new sidelink RNTI (wherein the new sidelink RNTI can be generated based on at least one of the source ID or the CO-sharing ID): (1) a PSCCH configuration 1, a PSCCH configuration 2, . . . , a PSCCH configuration N3.

In one embodiment, in the examples of this disclosure, the “PSCCH configuration 1,” “PSCCH configuration 2,” . . . , “PSCCH configuration N3” included in the SCI format can be further subject to a higher layer parameter being configured, and the value of N3 can be determined based on the higher layer parameter.

In another embodiment, in the examples of this disclosure, N3 can be fixed in the specification and/or pre-configured, e.g., N3=1.

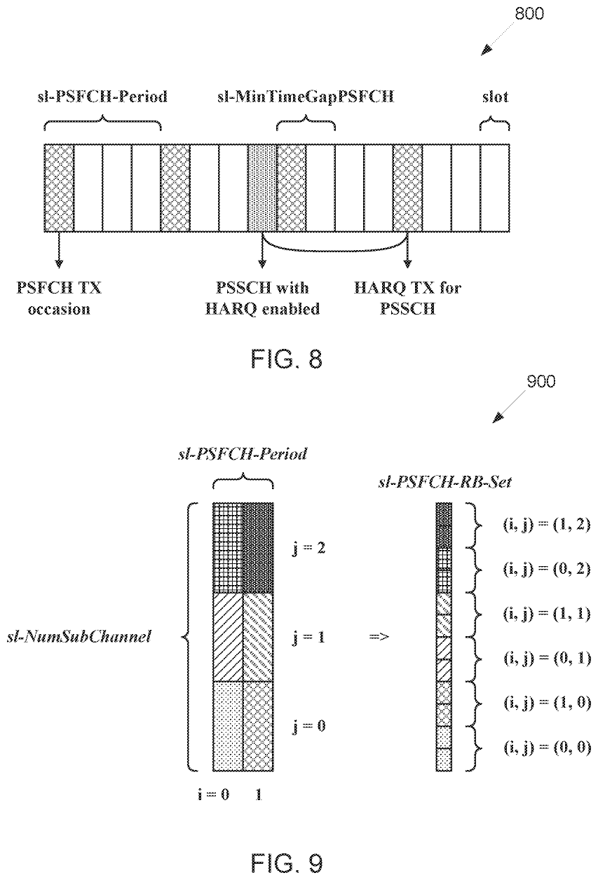

In time domain, the UE can be further provided a number of slots (e.g., sl-PSFCH-Period) in the resource pool for a period of PSFCH transmission occasion resources, and a slot in the resource pool is determined as containing a PSFCH transmission occasion, if the relative slot index within the resource pool is an integer multiple of the period of PSFCH transmission occasion, and with at least a number of slots provided by sl-MinTimeGapPSFCH after the last slot of the PSSCH reception. PSFCH is transmitted in two contiguous symbols in a slot, wherein the second symbol is with index startSLsymbols+lengthSLsymbols−2, and the two symbols are repeated. An illustration of the time domain resource determination for PSFCH is illustrated in FIG. 8.

FIG. 8 illustrates an example of time domain resource determination for PSFCH 800 according to embodiments of the present disclosure. The embodiment of the time domain resource determination for PSFCH 800 illustrated in FIG. 8 is for illustration only.

In a frequency domain, a PSFCH is transmitted in a single PRB, wherein the PRB is determined from a set of M_{PRB,set}^{PSFCH} PRBs based on an indication of a bitmap (e g sl-PSFCH-RB-Set). The UE determines a mapping from slot i (within N_{PSSCH}^{PSFCH} slots provided by sl-PSFCH-Period) and sub-channel j (within N_{subch} sub-channels provided by sl-NumSubchannel) to a subset of PRBs within the set of M_{PRB,set}^{PSFCH}, wherein the subset of PRBs are with index from (i+j·N_{PSSCH}^{PSFCH})·M_{subch,slot}^{PSFCH} to (i+1+j·N_{PSSCH}^{PSFCH})·M_{subch,slot}^{PSFCH}−1, with M_{subch,slot}^{PSFCH}=M_{PRB,set}^{PSFCH}/(N_{subch}·N_{PSSCH}^{PSFCH}).

FIG. 9 illustrates an example of frequency domain resource determination for PSFCH 900 according to embodiments of the present disclosure. The embodiment of the frequency domain resource determination for PSFCH 900 illustrated in FIG. 9 is for illustration only.

An illustration of this mapping is shown in FIG. 9. The UE determines a number of PSFCH resources available for multiplexing HARQ-ACK information in a PSFCH transmission as R_{PRB,CS}^{PSFCH}=N_{type}^{PSFCH}·M_{subch,slot}^{PSFCH}·N_{CS}^{PSFCH}, wherein N_{type}^{PSFCH} is determined based on the type of resources that the PSFCH is associated with, and N_{CS}^{PSFCH} is a number of cyclic shift pairs for the resource pool provided by sl-NumMuxCS-Pair. The UE determines an index of a PSFCH resource for a PSFCH transmission in response to a PSSCH reception as (P_{ID}+M_{ID}) mod R_{PRB,CS}^{PFSCH} where P_{ID} is the source ID provided by the SCI scheduling the PSSCH, and M_{ID} is the PSSCH receiver ID in groupcast SL transmission with ACK or NACK information in HARQ-feedback.

In Rel-16, NR is supported on unlicensed or shared spectrum, and a channel access procedure and a cyclic prefix extension are jointly coded and indicated using a DCI format, wherein the channel access procedure and the cyclic prefix extension can be applied to an uplink transmission on the unlicensed or shared spectrum.

For a sidelink operation on unlicensed or shared spectrum, there is a need to enhance channel access procedure and/or adjustment of symbol duration (e.g., CP extension) in a DCI and/or SCI. It is noted that the embodiments and/or examples in this disclosure can be used for sidelink operating on unlicensed or shared spectrum, but may not be limited to sidelink operating on unlicensed or shared spectrum. The embodiments and examples in this disclosure can be supported separately or combined.

The present disclosure provides embodiments for indicating channel access procedure related parameter in a downlink control information format and/or a sidelink control information format. More precisely, the following components are provided in the present disclosure: (1) a description of a field for indicating channel access procedure related parameter; (2) an indication using the field in a downlink control information format; (3) an indication using the field in a sidelink control information format; (4) a UE behavior for channel access procedure with scheduled sidelink transmission (e.g., a scheduled sidelink transmission can be a sidelink transmission in Mode 1 resource allocation scheduled by a DCI or a sidelink transmission in Mode 2 resource allocation scheduled by a SCI); and (5) a UE behavior for channel access procedure with configured sidelink transmission (e.g., a configured sidelink transmission can be a sidelink transmission in Mode 2 resource allocation).

In one embodiment, a field can be included in a DCI format and/or an SCI format, wherein the field indicates at least one of a channel access procedure type (e.g., including the CAPC information if not explicitly mentioning) and/or symbol duration adjustment.

For one aspect, the channel access procedure type can include at least one of the following examples.

In one example, in a first type of sidelink channel access procedure (e.g., Type 1), the time duration spanned by the sensing slots that are sensed to be idle before a sidelink transmission is random (e.g., depending on a random number).

In one example, in a second type of sidelink channel access procedure (e.g., Type 2), the time duration spanned by the sensing slots that are sensed to be idle before a sidelink transmission is deterministic as a first positive number (e.g., 25 us).

In one example, in a third type of sidelink channel access procedure (e.g., Type 3), the time duration spanned by the sensing slots that are sensed to be idle before a sidelink transmission is deterministic as a second positive number (e.g., 16 us).

In a fourth type of sidelink channel access procedure (e.g., Type 4), the time duration spanned by the sensing slots that are sensed to be idle before a sidelink transmission is deterministic as zero.

In one example, there can be multiple channel access priority class (CAPC) associated with the sidelink channel access procedure. One example CAPC for Type 1 sidelink channel access procedure is shown in TABLE 1, and another example CAPC for Type 1 sidelink channel access procedure is shown in TABLE 2. In the tables, mₚ is a parameter for determining the sensing duration, CW_{min,p} and CW_{max,p} are minimum and maximum contention window size for the corresponding CAPC, T_{mcot,p} is the corresponding maximum channel occupancy time, and CWₚ is the allowed contention window size for the corresponding CAPC.

TABLE 1
Example CAPC for sidelink channel access procedure

| CAPC | | | | | |
|---|---|---|---|---|---|
| (p) | mₚ | CW_{min, p} | CW_{max, p} | T_{mcot, p} (ms) | allowed CWₚ sizes |
| 1 | 2 | 3 | 7 | 2 | {3, 7} |
| 2 | 2 | 7 | 15 | 4 | {7, 15} |
| 3 | 3 | 15 | 1023 | 6 or 10 | {15, 31, 63, 127, |
| | | | | | 255, 511, 1023} |
| 4 | 7 | 15 | 1023 | 6 or 10 | {15, 31, 63, 127, |
| | | | | | 255, 511, 1023} |
| 1 | 1 | 3 | 7 | 2 | {3, 7} |
| 2 | 1 | 7 | 15 | 3 | {7, 15} |
| 3 | 3 | 15 | 63 | 8 or 10 | {15, 31, 63} |
| 4 | 7 | 15 | 1023 | 8 or 10 | {15, 31, 63, 127, |
| | | | | | 255, 511, 1023} |

For another aspect, the symbol duration adjustment can include at least one of the following examples: (1) the symbol duration adjustment can be CP extension of the first symbol of the next sidelink transmission, and the length of the extended CP can be one from multiple pre-defined cases; (2) the symbol duration adjustment can be extension of the last symbol of the next sidelink transmission, and the length of the extended symbol can be one form multiple pre-defined cases; (3) the symbol duration adjustment can be repetition of the first symbol of the next sidelink transmission; and (4) the symbol duration adjustment can be repetition of the last symbol of the next sidelink transmission.

One example indication of channel access procedure type and/or symbol duration adjustment by the field is shown in TABLE 3. Another example for selecting entries for the indication of channel access procedure type and/or symbol duration adjustment by the field is shown in TABLE 4. Yet another example for selecting entries for the indication of channel access procedure type and/or symbol duration adjustment by the field is shown in TABLE 5.

TABLE 3
Example indication by the field

| Bit field mapped | Channel access procedure | Symbol duration |
|---|---|---|
| to index | type | adjustment case index |
| 0 | Type 4 channel access | 2 |
| | procedure | |
| 1 | Type 2 channel access | 3 |
| | procedure | |
| 2 | Type 2 channel access | 1 |
| | procedure | |
| 3 | Type 1 channel access | 0 |
| | procedure | |

TABLE 4
Example indication by the field

| | | Symbol duration | |
|---|---|---|---|
| Bit field mapped | Channel access | adjustment | |
| to index | procedure type | case index | CAPC |
| 0-3 | Type 4 channel access | 0 | 1-4 |
| | procedure | | |
| 4-7 | Type 4 channel access | 2 | 1-4 |
| | procedure | | |
| 8-11 | Type 3 channel access | 0 | 1-4 |
| | procedure | | |
| 12-15 | Type 3 channel access | 2 | 1-4 |
| | procedure | | |
| 16-19 | Type 2 channel access | 0 | 1-4 |
| | procedure | | |
| 20-23 | Type 2 channel access | 1 | 1-4 |
| | procedure | | |
| 24-27 | Type 2 channel access | 3 | 1-4 |
| | procedure | | |
| 28-31 | Type 1 channel access | 0 | 1-4 |
| | procedure | | |
| 32-35 | Type 1 channel access | 1 | 1-4 |
| | procedure | | |
| 36-39 | Type 1 channel access | 2 | 1-4 |
| | procedure | | |
| 40-43 | Type 1 channel access | 3 | 1-4 |
| | procedure | | |

TABLE 5
Example indication by the field

| Bit field mapped | |
|---|---|
| to index | CAPC |
| 0 | 1 |
| 1 | 2 |
| 2 | 3 |
| 3 | 4 |

In one embodiment, at least one field in a DCI format can be utilized to indicate at least one of a channel access procedure type (e.g., including the CAPC information if not explicitly mentioning) and/or symbol duration adjustment, wherein the content of the field can be according to at least one example in this disclosure.

In one aspect, the at least one field is with a positive number as bitwidth for operation with shared spectrum channel access, and with zero bitwidth for operation without shared spectrum channel access.

In another aspect, the at least one field is with the same bitwidth for operation with and without shared spectrum channel access. For one further example, a UE can ignore this field for operation without shared spectrum channel access.

In one aspect, the DCI format can be the DCI format 3_0, which is utilized for scheduling of NR PSSCH and/or NR PSCCH in a cell.

In another aspect, the DCI format can be a new DCI format utilized for sidelink operation (e.g., other than DCI format 3_0 and DCI format 3_1).

In one aspect, the bitwidth of the at least one field can be fixed, when the field is present in the DCI. For one example, the fixed bitwidth can be 2. For another example, the fixed bitwidth can be 3. For yet another example, the fixed bitwidth can be 4. For yet another example, the fixed bitwidth can be 5. For yet another example, the fixed bitwidth can be 6.

In another aspect, the bitwidth of the at least one field can be determined as ┌log₂ (I)┐, wherein I is the number of entries pre-configured or provided by a higher layer parameter, and the entries are selected from a predefined table.

In yet another aspect, the bitwidth of the at least one field can depend on the format of the DCI. For example, for a first set of DCI formats, the bitwidth of the at least one field can be fixed according to a first example of this disclosure; and for a second set of DCI formats, the bitwidth of the at least one field can be determined as ┌log₂ (I)┐ according to a second example of this disclosure.

In yet another aspect, the bitwidth of the at least one field can be decided independently for each of the field, when multiple fields are included in the DCI format, and for each of the bitwidth can be determined according to one of the examples of this disclosure.

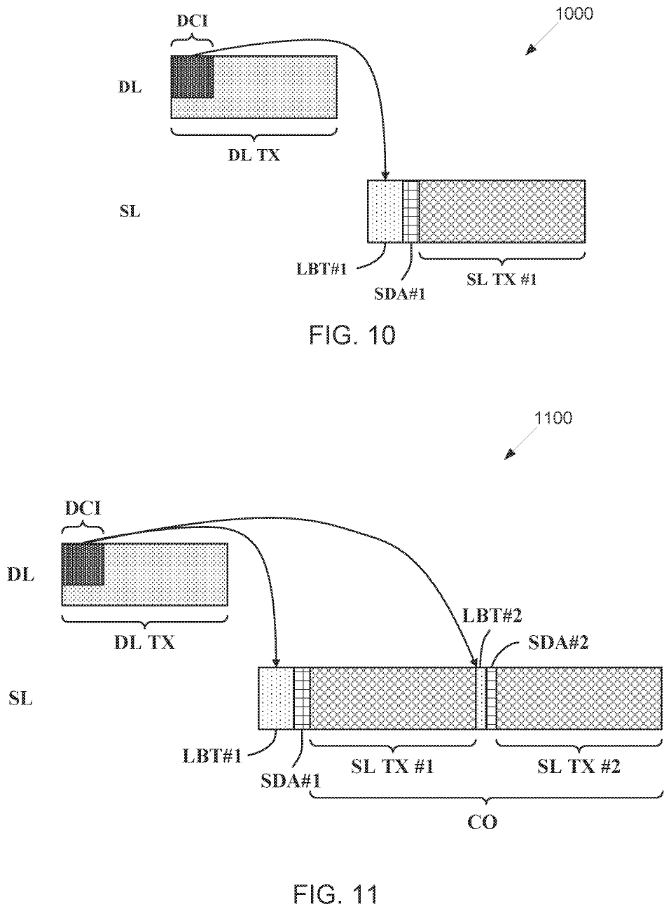

In one aspect, there is only one field in a DCI format which can be utilized to indicate at least one of a channel access procedure type and/or symbol duration adjustment. An illustration is shown in FIG. 10, wherein the indicated channel access procedure type (e.g., LBT) and/or symbol duration adjustment (SDA) is applied according to at least one of the following examples.

For one example, the indicated channel access procedure type and/or symbol duration adjustment by the one field can be applicable to the first sidelink transmission after reception of the DCI.

For another example, the indicated channel access procedure type and/or symbol duration adjustment by the one field can be applicable to the first sidelink transmission scheduled by the DCI.

For yet another example, the indicated channel access procedure type and/or symbol duration adjustment by the one field can be applicable to the all the sidelink transmission(s) scheduled by the DCI.

For yet another example, the indicated channel access procedure type (other than the CAPC information) and/or symbol duration adjustment by the one field can be applicable to the sidelink transmission other than the first transmission within the channel occupancy, and the CAPC information can be applicable to the sidelink transmission as the first transmission within the channel occupancy.

For yet another example, multiple of above examples can be supported, and the selection of the examples can be according to at least one of a pre-configuration, a configuration by higher layer parameter, or an indication in the DCI which includes the field.

FIG. 10 illustrates an example of single field indication in the DCI 1000 according to embodiments of the present disclosure. The embodiment of the single field indication in the DCI 1000 illustrated in FIG. 10 is for illustration only.

In another aspect, there are two fields in a DCI format which can be utilized to indicate at least one of a channel access procedure type and/or symbol duration adjustment.

FIG. 11 illustrates an example of two fields indication in the DCI 1100 according to embodiments of the present disclosure. The embodiment of the two fields indication in the DCI 1100 illustrated in FIG. 11 is for illustration only.

An illustration is shown in FIG. 11, wherein the indicated channel access procedure type (e.g., LBT) and/or SDA is applied according to at least one of the following examples.

For one example, the indicated channel access procedure type and/or symbol duration adjustment by one of the two fields can be applicable to the sidelink transmission which is the first transmission within a channel occupancy.

For another example, the indicated channel access procedure type and/or symbol duration adjustment by the other of the two fields can be applicable to the sidelink transmission which is located within a channel occupancy but not the first one.

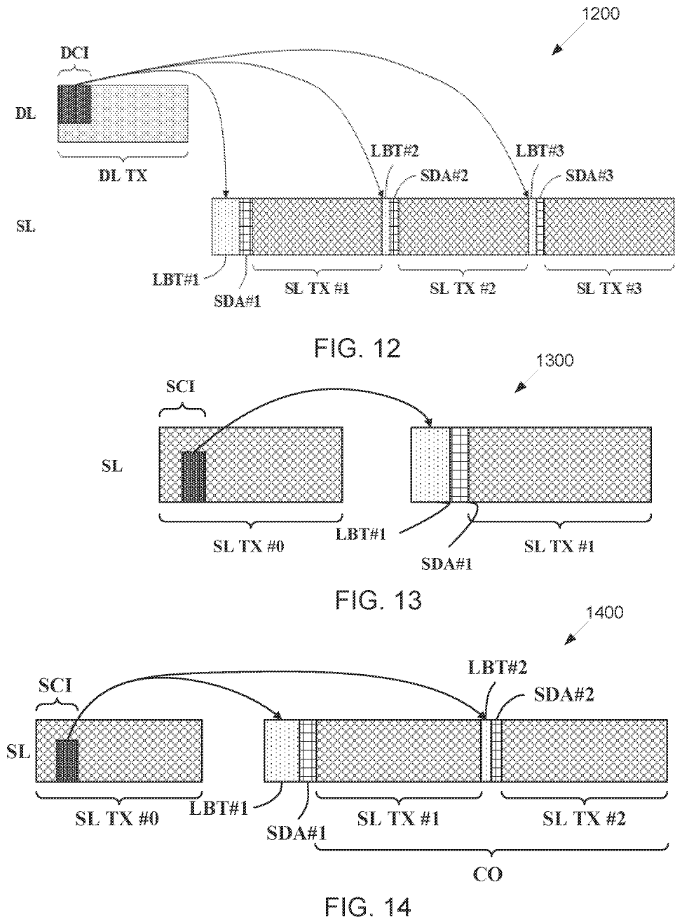

In yet another aspect, there can be one or multiple fields in a DCI format which can be utilized to indicate at least one of a channel access procedure type and/or symbol duration adjustment. An illustration is shown in FIG. 12, wherein the indicated channel access procedure type (e.g., LBT) and/or SDA is applied according to at least one of the following examples.

For one example, there can be a one-to-one mapping between a field and a scheduled SL transmission (e.g., PSSCH), and the indicated channel access procedure type (e.g., LBT) and/or SDA from each field can be applicable to the corresponding scheduled SL transmission (e.g., PSSCH).

For another example, the indicated channel access procedure type (e.g., LBT) and/or SDA from each field within the one or multiple fields can be applicable to a set of SL transmissions respectively. For one sub-example, the set of SL transmissions are the ones scheduled by the DCI which includes the one or multiple fields. For another sub-example, the set of SL transmissions are the ones following the reception of the DCI which includes the one or multiple fields.

FIG. 12 illustrates an example of one or multiple fields indication in the DCI 1200 according to embodiments of the present disclosure. The embodiment of the one or multiple fields indication in the DCI 1200 illustrated in FIG. 12 is for illustration only.

In one aspect, the at least one field in a DCI format utilized to indicate at least one of a channel access procedure type and/or symbol duration adjustment can be applicable to Mode 1 sidelink transmission.

In one embodiment, at least one field in a sidelink DCI format can be utilized to indicate at least one of a channel access procedure type (e.g., including the CAPC information if not explicitly mentioning) and/or symbol duration adjustment, wherein the content of the field can be according to at least one example in this disclosure.

In one aspect, the at least one field is with a positive number as bitwidth for operation with shared spectrum channel access, and with zero bitwidth for operation without shared spectrum channel access.

In another aspect, the at least one field is with the same bitwidth for operation with and without shared spectrum channel access. For one example, a UE can ignore this field for operation without shared spectrum channel access.

In one aspect, the SCI format can be the SCI format 1-A, which is utilized for scheduling of NR PSSCH and the second stage SCI on NR PSSCH.

In another aspect, the SCI format can be the SCI format 2-A, which is utilized for decoding PSSCH.

In yet another aspect, the SCI format can be the SCI format 2-B, which is utilized for decoding PSSCH.

In yet another aspect, the SCI format can be the SCI format 2-C, which is utilized for providing or requesting inter-UE coordination information.

In yet another aspect, the SCI format can be a new SCI format utilized for sidelink operation (e.g., other than SCI format 1-A, 2-A, 2-B, and 2-C).

In one aspect, the bitwidth of the at least one field can be fixed, when the field is present in the SCI. For one example, the fixed bitwidth can be 2. For another example, the fixed bitwidth can be 3. For yet another example, the fixed bitwidth can be 4. For yet another example, the fixed bitwidth can be 5. For yet another example, the fixed bitwidth can be 6.

In another aspect, the bitwidth of the at least one field can be determined as ┌log₂(I)┐, wherein I is the number of entries pre-configured or provided by a higher layer parameter, and the entries are selected from a predefined table (e.g., a table according to another embodiment of this disclosure).

In yet another aspect, the bitwidth of the at least one field can depend on the format of the SCI. For example, for a first set of SCI formats, the bitwidth of the at least one field can be fixed according to a first example of this disclosure; and for a second set of SCI formats, the bitwidth of the at least one field can be determined as ┌log₂ (I)┐ according to a second example of this disclosure.

In yet another aspect, the bitwidth of the at least one field can be decided independently for each of the field, when multiple fields are included in the SCI format, and for each of the bitwidth can be determined according to one of the examples of this disclosure.

In one aspect, there is only one field in a SCI format which can be utilized to indicate at least one of a channel access procedure type and/or symbol duration adjustment. An illustration is shown in FIG. 13, wherein the indicated channel access procedure type (e.g., LBT) and/or SDA is applied according to at least one of the following examples.

For one example, the indicated channel access procedure type and/or symbol duration adjustment by the one field can be applicable to the first sidelink transmission after reception of the SCI.

For another example, the indicated channel access procedure type and/or symbol duration adjustment by the one field can be applicable to the first sidelink transmission scheduled by the SCI.

For yet another example, the indicated channel access procedure type and/or symbol duration adjustment by the one field can be applicable to the all the sidelink transmission(s) scheduled by the SCI.

For yet another example, the indicated channel access procedure type (other than the CAPC information) and/or symbol duration adjustment by the one field can be applicable to the sidelink transmission other than the first transmission within the channel occupancy, and the CAPC information can be applicable to the sidelink transmission as the first transmission within the channel occupancy.

For yet another example, multiple of above examples can be supported, and the selection of the examples can be according to at least one of a pre-configuration, a configuration by higher layer parameter, or an indication in the SCI which includes the field.

FIG. 13 illustrates an example of single field indication in the DCI 1300 according to embodiments of the present disclosure. The embodiment of the single field indication in the DCI 1300 illustrated in FIG. 13 is for illustration only.

In another aspect, there are two fields in a SCI format which can be utilized to indicate at least one of a channel access procedure type and/or symbol duration adjustment. An illustration is shown in FIG. 14, wherein the indicated channel access procedure type (e.g., LBT) and/or SDA is applied according to at least one of the following examples.

For one example, the indicated channel access procedure type and/or symbol duration adjustment by one of the two fields can be applicable to the sidelink transmission which is the first transmission within a channel occupancy.

For another example, the indicated channel access procedure type and/or symbol duration adjustment by the other of the two fields can be applicable to the sidelink transmission which is located within a channel occupancy but not the first one.

FIG. 14 illustrates an example of two fields indication in the DCI 1400 according to embodiments of the present disclosure. The embodiment of the two fields indication in the DCI 1400 illustrated in FIG. 14 is for illustration only.

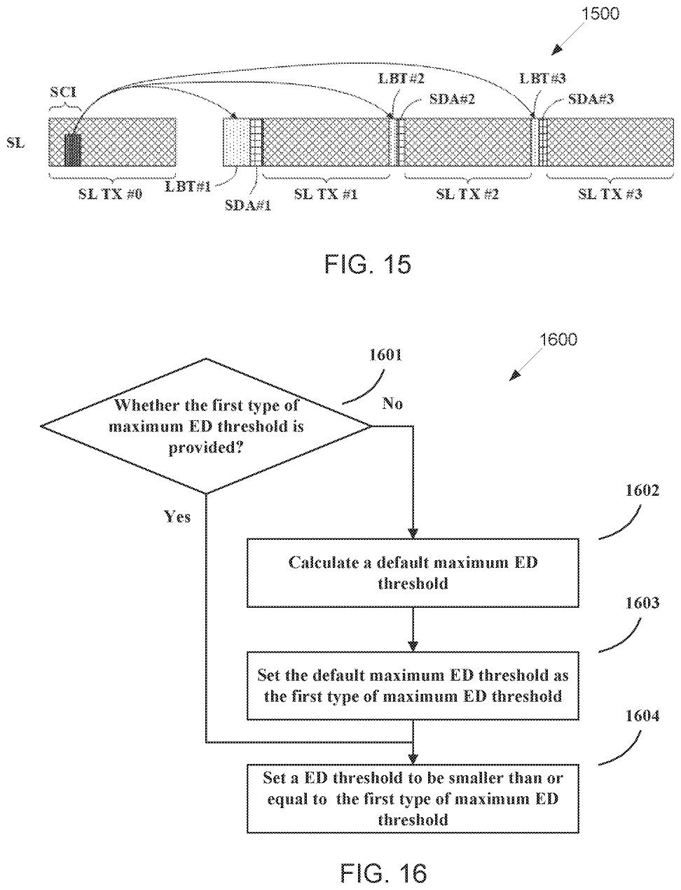

In yet another aspect, there can be one or multiple fields in a SCI format which can be utilized to indicate at least one of a channel access procedure type and/or symbol duration adjustment. An illustration is shown in FIG. 15, wherein the indicated channel access procedure type (e.g., LBT) and/or SDA is applied according to at least one of the following examples.

For one example, there can be a one-to-one mapping between a field and a scheduled SL transmission (e.g., PSSCH), and the indicated channel access procedure type (e.g., LBT) and/or SDA from each field can be applicable to the corresponding scheduled sidelink transmission (e.g., PSSCH).

For another example, the indicated channel access procedure type (e.g., LBT) and/or SDA from each field within the one or multiple fields can be applicable to a set of SL transmissions respectively. For one sub-example, the set of SL transmissions are the ones scheduled by the SCI which includes the one or multiple fields. For another sub-example, the set of SL transmissions are the ones following the reception of the SCI which includes the one or multiple fields.

FIG. 15 illustrates an example of one or multiple fields indication in the DCI 1500 according to embodiments of the present disclosure. The embodiment of the one or multiple fields indication in the DCI 1500 illustrated in FIG. 15 is for illustration only.

In one aspect, the at least one field in a SCI format utilized to indicate at least one of a channel access procedure type and/or symbol duration adjustment can be applicable to Mode 1 sidelink transmission.

In another aspect, the at least one field in a SCI format utilized to indicate at least one of a channel access procedure type and/or symbol duration adjustment can be applicable to Mode 2 sidelink transmission.

In one aspect, if a UE fails to access the channel(s) prior to an intended sidelink transmission, layer 1 notifies higher layers about the channel access failure.

In one aspect, a UE uses the indicated type of channel access procedure for accessing the channel before sidelink transmission(s), other than examples which allows other types of channel access procedure(s) as described in this disclosure.

In another aspect, a UE uses the indicated symbol duration adjustment (e.g., CP extension) applied for the sidelink transmission(s), other than examples which allows other symbol duration adjustment (e.g., CP extension) as described in this disclosure.

In one aspect, if a UE is indicated to use Type 1 channel access procedure for a SL transmission as described in the example of this disclosure, and the UE determines the SL transmission is within a channel occupancy from both the time domain and frequency domain perspectives, the UE can switch from Type 1 channel access procedure to Type 2 channel access procedure for that SL transmission.

In another aspect, if a UE is indicated to use Type 1 channel access procedure for a SL transmission as described in the example of this disclosure, and the UE determines the SL transmission is within a channel occupancy from both the time domain and frequency domain perspectives, the UE can switch from Type 1 channel access procedure to Type 3 channel access procedure for that SL transmission.

In yet another aspect, if a UE is indicated to use Type 1 channel access procedure for a SL transmission as described in the example of this disclosure, and the UE determines the SL transmission is within a channel occupancy from both the time domain and frequency domain perspectives, the UE can switch from Type 1 channel access procedure to Type 4 channel access procedure for that SL transmission.

In one aspect, if a UE intends (e.g., is scheduled) to transmit a set of contiguous sidelink transmissions without any gap, and the UE transmits one of the scheduled sidelink transmissions in the set after accessing the channel according to one of the channel access procedure as described in the example of this disclosure, the UE may continue transmitting the remaining sidelink transmission in the set, if any.

In one aspect, if a UE intends (e.g., is scheduled) to transmit a set of contiguous sidelink transmissions, and if the UE cannot access the channel for a transmission in the set prior to the last transmission according to Type 1 channel access procedure as described in the example of this disclosure, the UE may attempt to transmit the next transmission according to the channel access type indicated in the corresponding DCI and/or SCI.

In another aspect, if a UE intends (e.g., is scheduled) to transmit a set of contiguous sidelink transmissions, and if the UE cannot access the channel for a transmission in the set prior to the last transmission according to Type 2 channel access procedure as described in the example of this disclosure, the UE may attempt to transmit the next transmission according to the channel access type indicated in the corresponding DCI and/or SCI.

In yet another aspect, if a UE intends (e.g., is scheduled) to transmit a set of contiguous sidelink transmissions, and if the UE cannot access the channel for a transmission in the set prior to the last transmission according to Type 3 channel access procedure as described in the example of this disclosure, the UE may attempt to transmit the next transmission according to Type 2 channel access procedure.

In one aspect, if a UE intends (e.g., is scheduled) to transmit a set of contiguous sidelink transmissions without any gap, the UE is not expected to be indicated with different channel access types in between the contiguous transmissions, expect if Type 2 or Type 3 channel access procedures are identified for the first of the consecutive sidelink transmissions.

In one aspect, if a UE intends (e.g., is scheduled) to transmit a set of contiguous sidelink transmission without any gap, and if the UE has stopped transmitting during or before one transmission in the set (prior to the last transmission), the UE may resume transmitting a later sidelink transmission in the set using Type 2 channel access procedure as described in this disclosure. In one example, the UE may apply no symbol duration adjustment (e.g., CP extension) to the later sidelink transmission in the set.

In another aspect, if a UE intends (e.g., is scheduled) to transmit a set of contiguous sidelink transmission without any gap, and if the UE has stopped transmitting during or before one transmission in the set (prior to the last transmission), and the channel sensed by the UE is not idle after the UE has stopped transmitting, the UE may resume transmitting a later sidelink transmission in the set using Type 1 channel access procedure as described in this disclosure. In one example, the UE may apply the channel access priority class as indicated in the corresponding DCI and/or SCI. In another further example, the UE may apply no symbol duration adjustment (e.g., CP extension) to the later sidelink transmission in the set. In yet another example, the UE may apply symbol duration adjustment (e.g., CP extension) to the later sidelink transmission in the set as indicated in the corresponding DCI and/or SCI.

In one aspect, if a UE intends (e.g., is scheduled) to transmit a set of non-contiguous sidelink transmissions, and if the UE has stopped transmitting during or before one transmission in the set (prior to the last transmission), the UE may resume transmitting a later sidelink transmission in the set using Type 2 channel access procedure as described in this disclosure, if the channel is sensed by the UE to be continuously idle after the UE has stopped transmitting. In one example, the UE may apply no symbol duration adjustment (e.g., CP extension) to the later sidelink transmission in the set.

In another aspect, if a UE intends (e.g., is scheduled) to transmit a set of non-contiguous sidelink transmission, and if the UE has stopped transmitting during or before one transmission in the set (prior to the last transmission), and the channel sensed by the UE is not idle after the UE has stopped transmitting, the UE may resume transmitting a later sidelink transmission in the set using Type 1 channel access procedure as described in this disclosure. In one example, the UE may apply the channel access priority class as indicated in the corresponding DCI and/or SCI. In another further example, the UE may apply no symbol duration adjustment (e.g., CP extension) to the later sidelink transmission in the set. In yet another example, the UE may apply symbol duration adjustment (e.g., CP extension) to the later sidelink transmission in the set as indicated in the corresponding DCI and/or SCI.

In one aspect, if a UE is indicated, e.g., by a DCI and/or SCI, to perform Type 1 channel access procedure for a scheduled sidelink transmission, and the UE has an ongoing Type 1 channel access procedure prior to the scheduled sidelink transmission starting time, and if the CAPC value corresponding to the ongoing Type 1 channel access procedure is same or larger than the CAPC value indicated, e.g., by the DCI and/or SCI, the UE may transmit the scheduled sidelink transmission by assessing the channel by using the ongoing Type 1 channel access procedure.

In another aspect, if a UE is indicated, e.g., by a DCI and/or SCI, to perform Type 1 channel access procedure for a scheduled sidelink transmission, and the UE has an ongoing Type 1 channel access procedure prior to the scheduled sidelink transmission starting time, and if the CAPC value corresponding to the ongoing Type 1 channel access procedure is less than the CAPC value indicated, e.g., by the DCI and/or SCI, the UE terminates the ongoing Type 1 channel access procedure.

In one aspect, a UE can be indicated, e.g., by a DCI and/or SCI, to perform one from Type 2, Type 3, or Type 4 channel access procedure for a scheduled sidelink transmission, and if the scheduled sidelink transmission(s) occur within the channel occupancy time (e.g., including the gap(s) longer than 25 us).

In another aspect, if a UE can be indicated, e.g., by a DCI and/or SCI, to perform one from Type 2, Type 3, or Type 4 channel access procedure for a scheduled sidelink transmission, the UE can assume the CAPC indicated in the same DCI and/or SCI is associated with the channel access procedure which initializes the channel occupancy.

In yet another aspect, the UE can assume the CAPC indicated in the DCI and/or SCI is associated with the channel access procedure which initializes the channel occupancy.

In one aspect, when gap between SL transmissions is at least 25 us, a UE can be indicated with Type 2 channel access procedure, e.g., by a DCI and/or SCI.

In another aspect, when gap between SL transmissions is equal to 16 us, a UE can be indicated with Type 3 channel access procedure, e.g., by a DCI and/or SCI.

In yet another aspect, when gap between SL transmissions is up to 16 us, a UE can be indicated with Type 4 channel access procedure, e.g., by a DCI and/or SCI.

In one aspect, if a UE received an indication of channel access type and/or symbol duration adjustment for a sidelink transmission from a DCI, and received an indication of channel access type and/or symbol duration adjustment for the same sidelink transmission from a SCI, the UE assume the indicated channel access type and/or symbol duration adjustment is the same in the DCI and the SCI.

In another aspect, if a UE received an indication of channel access type and/or symbol duration adjustment for a sidelink transmission from a DCI, and received an indication of channel access type and/or symbol duration adjustment for the same sidelink transmission from a SCI, the UE assumes the indication from the DCI overrides the indication from the SCI.

In yet another aspect, if a UE received an indication of channel access type and/or symbol duration adjustment for a sidelink transmission from a DCI, and received an indication of channel access type and/or symbol duration adjustment for the same sidelink transmission from a SCI, the UE assumes the indication from the SCI overrides the indication from the DCI.

In one aspect, if a UE received an indication of channel access type and/or symbol duration adjustment for a sidelink transmission from a DCI, and the UE is going to transmit a SCI that schedules the same sidelink transmission, then the UE uses the same information on the channel access type and/or symbol duration adjustment to be included in the SCI.

In one aspect, a UE uses Type 1 channel access procedure for transmitting (e.g., configured) sidelink transmission(s), other than examples which allows other types of channel access procedure(s) as described in this disclosure.

In one aspect, if a UE intends (e.g., is configured) to transmit a set of contiguous sidelink transmissions without any gap, wherein the time domain resource configuration defines multiple transmission occasions, and the UE transmits one of the sidelink transmissions in the set in one of the transmission occasions after accessing the channel according to one of the channel access procedure as described in the example of this disclosure, the UE may continue transmitting the remaining sidelink transmission in the set, if any.

In one aspect, if a UE intends (e.g., is configured) to transmit a set of contiguous sidelink transmissions, wherein the time domain resource configuration defines multiple transmission occasions, and if the UE cannot access the channel for a transmission in the set in a transmission occasion prior to the last transmission according to Type 1 channel access procedure as described in the example of this disclosure, the UE may attempt to transmit the next transmission according to Type 1 channel access procedure.

In one aspect, if a UE intends (e.g., is scheduled) to transmit sidelink transmission(s) starting from symbol i in slot n using Type 1 channel access procedure with a corresponding CAPC, as described in example of this disclosure, wherein for example the sidelink transmission is without symbol duration adjustment (e.g., CP extension), and if the UE starts sidelink transmission before symbol i in slot n using Type 1 channel acces procedure with a corresponding CAPC, and the scheduled sidelink transmission(s) occupies all the RBs of the same channels (e.g., LBT bandwidth or RB-sets) occupied by the configured sidelink transmission(s), or the scheduled sidelink transmission(s) occupies all the RBs of a subset of channels (e.g., LBT bandwidth or RB-sets) occupied by the configured sidelink transmission(s), the UE may directly continue to transmit the scheduled sidelink transmission(s) to from symbol i in slot n without a gap, if the CAPC value of the performed channel access procedure for the configured sidelink transmission(s) is no less than the CAPC value of the channel access procedure for the scheduled sidelink transmission(s).

In one example, the sum of the transmission durations of the configured sidelink transmission(s) and scheduled sidelink transmission(s) does not exceed the maximum channel occupancy time (MCOT) duration corresponding to the CAPC of the performed channel access procedure for the configured sidelink transmission(s).

In another aspect, if a UE intends (e.g., is scheduled) to transmit sidelink transmission(s) starting from symbol i in slot n using Type 1 channel acces procedure with a corresponding CAPC, as described in example of this disclosure, wherein for example the sidelink transmission is without symbol duration adjustment (e.g., CP extension), and if the UE starts configured sidelink transmission before symbol i in slot n using Type 1 channel acces procedure with a corresponding CAPC, and the scheduled sidelink transmission(s) occupies all the RBs of the same channels (e.g., LBT bandwidth or RB-sets) occupied by the configured sidelink transmission(s), or the scheduled sidelink transmission(s) occupies all the RBs of a subset of channels (e.g., LBT bandwidth or RB-sets) occupied by the configured sidelink transmission(s), the UE terminates the configured sidelink transmission(s) by dropping the transmission on symbols of at least the last configured transmission before from symbol i in slot n, and attempts to transmit the scheduled sidelink transmission(s) using channel access procedure with the corresponding CAPC, if the CAPC value of the performed channel access procedure for the configured sidelink transmission(s) is less than the CAPC value of the channel access procedure for the scheduled sidelink transmission(s).

In Rel-16 NR-U, for operation with shared spectrum channel access (e.g., unlicensed or shared spectrum), a transmitter may perform sensing that evaluates the availability of a channel for performing transmissions. For energy detection based sensing, a basic unit for sensing is defined as a sensing slot. A channel with a duration of s sensing slot is declared as idle, if the transmitter senses the channel during the sensing slot duration and determines that the detected power for a given portion of the sensing slot duration is less than a maximum energy detection threshold, or declared as busy otherwise.

For a sidelink operation over an unlicensed spectrum, the transmission of sidelink signals and channels may be subject to the channel access procedure, and the sensing results can also be compared with a maximum energy detection threshold. This disclosure focuses on the adaptation of the energy detection threshold for sidelink operated over an unlicensed spectrum.

The present disclosure provides embodiments for an adaptation of energy detection threshold for sidelink transmission on the unlicensed spectrum. More precisely, the present disclosure provides the following components: (1) an indication of a first type of maximum energy detection threshold; (2) an indication of a second type of maximum energy detection threshold; (3) an indication of an offset for the first type of maximum energy detection threshold; (4) an indication of an offset for the second type of maximum energy detection threshold; (5) a condition to use the first and/or the second type of maximum energy detection threshold; (6) calculation of the default maximum energy detection threshold; and (7) channel occupancy sharing for configured sidelink transmission.

In one embodiment, at least one first type of maximum energy detection (ED) threshold can be provided to a UE, with potential condition to apply the first type of maximum energy detection threshold as described in the examples of this disclosure.

In one example, the at least one first type of maximum energy detection threshold can be provided to a UE by a pre-configuration.

In another example, the at least one first type of maximum energy detection threshold can be configured by a gNB using a higher layer parameter (e.g., a RRC parameter). For one instance, the at least one first type of maximum energy detection threshold can be associated with a resource pool configured by the gNB (e.g., per resource pool). In another instance, the at least one first type of maximum energy detection threshold can be associated with a cell of the gNB (e.g., per cell).

In yet another example, the at least one first type of maximum energy detection threshold can be configured by a UE using a higher layer parameter (e.g., a PC5 RRC parameter). For one instance, the at least one first type of maximum energy detection threshold can be associated with a resource pool (e.g., per resource pool). In another instance, the at least one first type of maximum energy detection threshold can be associated with a UE (e.g., per UE).

In one example, the candidate values of the at least one first type of maximum energy detection threshold can be determined based on a sidelink priority (e.g., the transmission priority). For instance, there can be a mapping between the candidate value(s) of the at least one first type of maximum energy detection threshold to a sidelink priority, and when the sidelink priority is higher, the corresponding applicable candidate value(s) of the at least one first type of maximum energy detection threshold is higher.

FIG. 16 illustrates a flowchart of a method 1600 for a UE procedure for setting an energy detection threshold using the first type of maximum energy detection threshold according to embodiments of the present disclosure. The embodiment of the method 1600 illustrated in FIG. 16 is for illustration only. The method 1600 as may be performed by a UE (e.g., 111-116 as illustrated in FIG. 1). One or more of the components illustrated in FIG. 16 can be implemented in specialized circuitry configured to perform the noted functions or one or more of the components can be implemented by one or more processors executing instructions to perform the noted functions.

An example UE procedure to set the energy detection threshold based on the first type of maximum energy detection threshold is shown in FIG. 16. For instance, this example can be applied when the offset for the first type of maximum energy detection threshold is not supported.

The UE determines whether the first type of maximum energy detection threshold is provided (1601).

If the first type of maximum energy detection threshold is provided to the UE, the UE can set the energy detection threshold (e.g., X_{Thresh}) to be less than or equal to the first type of maximum energy detection threshold provided to the UE (1604).

If the first type of maximum energy detection threshold is not provided to the UE, the UE can calculate a default maximum energy detection threshold (e.g., X′_{Thresh_max}) (1602) and set the default maximum energy detection threshold as the first type of maximum energy detection threshold (1603), then the UE can set the energy detection threshold (e.g., X_{Thresh}) to be less than or equal to the first type of maximum energy detection threshold (1604).

In one embodiment, at least one second type of maximum ED threshold can be provided to a UE, with potential condition to apply the second type of maximum energy detection threshold as described in the examples of this disclosure.

In one example, the at least one second type of maximum energy detection threshold can be provided to a UE by a pre-configuration.

In another example, the at least one second type of maximum energy detection threshold can be configured by a gNB using a higher layer parameter (e.g., a RRC parameter). For one instance, the at least one second type of maximum energy detection threshold can be associated with a resource pool configured by the gNB (e.g., per resource pool). In another instance, the at least one second type of maximum energy detection threshold can be associated with a cell of the gNB (e.g., per cell).

In yet another example, the at least one second type of maximum energy detection threshold can be configured by a UE using a higher layer parameter (e.g., a PC5 RRC parameter). For one instance, the at least one second type of maximum energy detection threshold can be associated with a resource pool (e.g., per resource pool). In another instance, the at least one second type of maximum energy detection threshold can be associated with a UE (e.g., per UE).

In one example, the candidate values of the at least one second type of maximum energy detection threshold can be determined based on a sidelink priority (e.g., the transmission priority). For instance, there can be a mapping between the candidate value(s) of the at least one second type of maximum energy detection threshold to a sidelink priority, and when the sidelink priority is higher, the corresponding applicable candidate value(s) of the at least one second type of maximum energy detection threshold is higher.

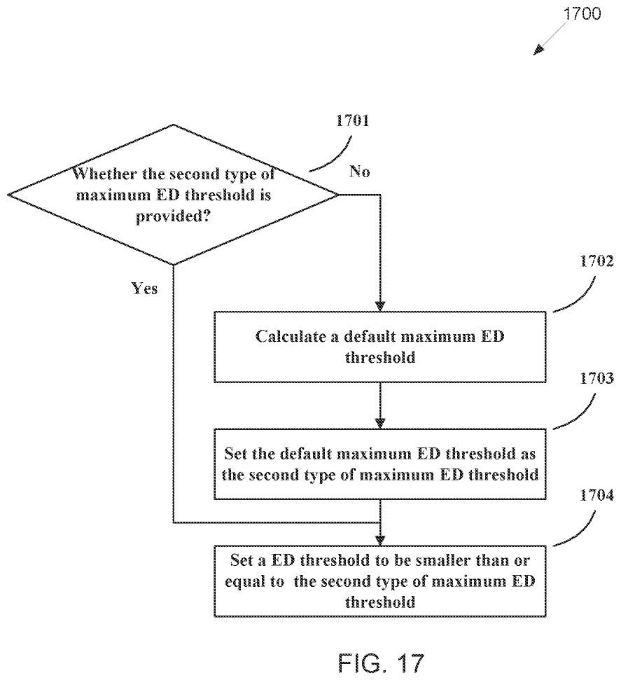

An example UE procedure to set the energy detection threshold based on the second type of maximum energy detection threshold is shown in FIG. 17. For instance, this example can be applied when the offset for the second type of maximum energy detection threshold is not supported.

FIG. 17 illustrates a flowchart of a method 1700 for a UE procedure for setting an energy detection threshold using the second type of maximum energy detection threshold according to embodiments of the present disclosure. The embodiment of the method 1700 illustrated in FIG. 17 is for illustration only. The method 1700 as may be performed by a UE (e.g., 111-116 as illustrated in FIG. 1). One or more of the components illustrated in FIG. 17 can be implemented in specialized circuitry configured to perform the noted functions or one or more of the components can be implemented by one or more processors executing instructions to perform the noted functions.

The UE determines whether the second type of maximum energy detection threshold is provided (1701).

If the second type of maximum energy detection threshold is provided to the UE, the UE can set the energy detection threshold (e.g., X_{Thresh}) to be less than or equal to the second type of maximum energy detection threshold provided to the UE (1704).

If the second type of maximum energy detection threshold is not provided to the UE, the UE can calculate a default maximum energy detection threshold (e.g., X′_{Thresh_max}) (1702) and set the default maximum energy detection threshold as the second type of maximum energy detection threshold (1703), then the UE can set the energy detection threshold (e.g., X_{Thresh}) to be less than or equal to the second type of maximum energy detection threshold (1704).

In one embodiment, an offset for the first type of maximum energy detection threshold can be provided to a UE, with potential condition to apply the first type of maximum energy detection threshold as described in the examples of this disclosure.

In one example, the offset for the first type of maximum energy detection threshold can be provided to a UE by a pre-configuration.

In another example, the offset for the first type of maximum energy detection threshold can be configured by a gNB using a higher layer parameter (e.g., a RRC parameter). For one instance, the offset for the first type of maximum energy detection threshold can be associated with a resource pool configured by the gNB (e.g., per resource pool). In another instance, the offset for the first type of maximum energy detection threshold can be associated with a cell of the gNB (e.g., per cell).

In yet another example, the offset for the first type of maximum energy detection threshold can be configured by a UE using a higher layer parameter (e.g., a PC5 RRC parameter). For one instance, the offset for the first type of maximum energy detection threshold can be associated with a resource pool (e.g., per resource pool). In another instance, the offset for the first type of maximum energy detection threshold can be associated with a UE (e.g., per UE).

In one example, the candidate values of the offset for the first type of maximum energy detection threshold can be determined based on a sidelink priority (e.g., the transmission priority). For instance, there can be a mapping between the candidate value(s) of the offset for the first type of maximum energy detection threshold to a sidelink priority, and when the sidelink priority is higher, the corresponding applicable candidate value(s) of offset for the first type of maximum energy detection threshold is higher.

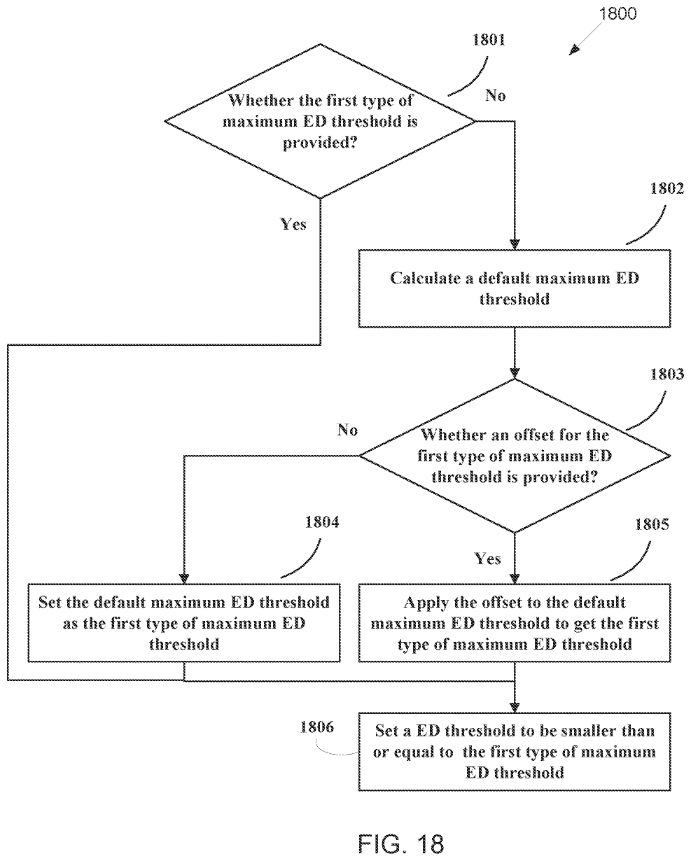

FIG. 18 illustrates a flowchart of a method 1800 for a UE procedure for setting an energy detection threshold using the first type of maximum energy detection threshold and/or the offset for the first type of maximum energy detection threshold according to embodiments of the present disclosure. The embodiment of the method 1800 illustrated in FIG. 18 is for illustration only. The method 1800 as may be performed by a UE (e.g., 111-116 as illustrated in FIG. 1). One or more of the components illustrated in FIG. 18 can be implemented in specialized circuitry configured to perform the noted functions or one or more of the components can be implemented by one or more processors executing instructions to perform the noted functions.

An example UE procedure to set the energy detection threshold based on the first type of maximum energy detection threshold and/or the offset for the first type of maximum energy detection threshold is shown in FIG. 18. For instance, this example can be applied when the offset for the first type of maximum energy detection threshold is supported.

The UE determines whether the first type of maximum energy detection threshold is provided (1801).

If the first type of maximum energy detection threshold is provided to the UE, the UE can set the energy detection threshold (e.g., X_{Thresh}) to be less than or equal to the first type of maximum energy detection threshold provided to the UE (1806).

If the first type of maximum energy detection threshold is not provided to the UE, the UE can calculate a default maximum energy detection threshold (e.g., X′_{Thresh_max}) (1802), according to an example of this disclosure, and further determines whether an offset for the first type of maximum energy detection threshold is provided (1803).

If the offset for the first type of maximum energy detection threshold is provided to the UE, the UE applies the offset for the first type of maximum energy detection threshold to the default maximum energy detection threshold (e.g., X′_{Thresh_max}) to determine the first type of maximum energy detection threshold (1805), and set the energy detection threshold (e.g., X_{Thresh}) to be less than or equal to the first type of maximum energy detection threshold (1806).

If the offset for the first type of maximum energy detection threshold is not provided to the UE, the UE sets the first type of maximum energy detection threshold as the default maximum energy detection threshold (e.g., X′_{Thresh_max}) (1804), and set the energy detection threshold (e.g., X Thresh) to be less than or equal to the first type of maximum energy detection threshold (1806).

In one embodiment, an offset for the second type of maximum energy detection threshold can be provided to a UE, with potential condition to apply the second type of maximum energy detection threshold as described in the examples of this disclosure.

In one example, the offset for the second type of maximum energy detection threshold can be provided to a UE by a pre-configuration.

In another example, the offset for the second type of maximum energy detection threshold can be configured by a gNB using a higher layer parameter (e.g., a RRC parameter). For one instance, the offset for the second type of maximum energy detection threshold can be associated with a resource pool configured by the gNB (e.g., per resource pool). In another instance, the offset for the second type of maximum energy detection threshold can be associated with a cell of the gNB (e.g., per cell).

In yet another example, the offset for the second type of maximum energy detection threshold can be configured by a UE using a higher layer parameter (e.g., a PC5 RRC parameter). For one instance, the offset for the second type of maximum energy detection threshold can be associated with a resource pool (e.g., per resource pool). In another instance, the offset for the second type of maximum energy detection threshold can be associated with a UE (e.g., per UE).

In one example, the candidate values of the offset for the second type of maximum energy detection threshold can be determined based on a sidelink priority (e.g., the transmission priority). For instance, there can be a mapping between the candidate value(s) of the offset for the second type of maximum energy detection threshold to a sidelink priority, and when the sidelink priority is higher, the corresponding applicable candidate value(s) of offset for the second type of maximum energy detection threshold is higher.

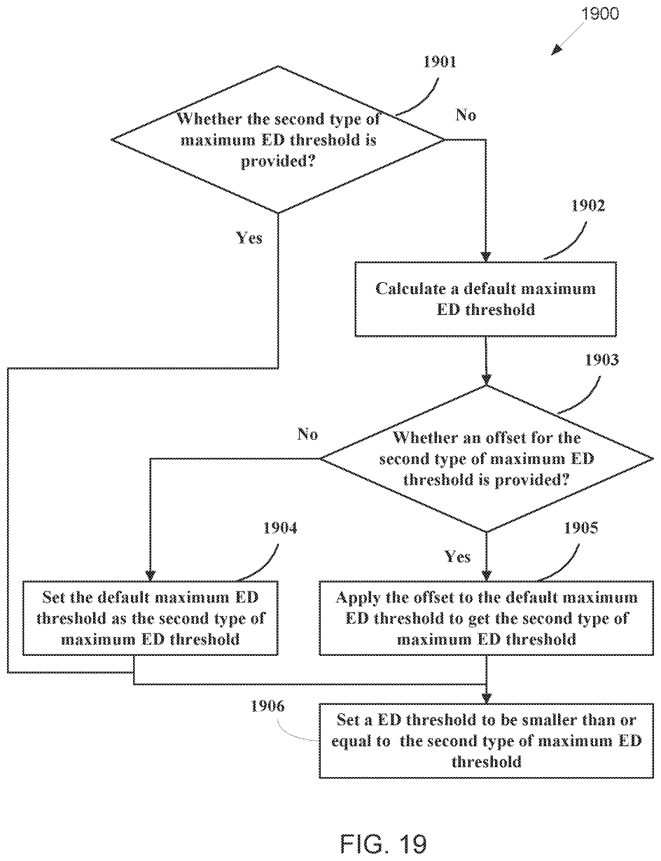

FIG. 19 illustrates a flowchart of a method 1900 for a UE procedure for setting an energy detection threshold using the second type of maximum energy detection threshold and/or the offset for the second type of maximum energy detection threshold according to embodiments of the present disclosure. The embodiment of the method 1900 illustrated in FIG. 19 is for illustration only. The method 1900 as may be performed by a UE (e.g., 111-116 as illustrated in FIG. 1). One or more of the components illustrated in FIG. 19 can be implemented in specialized circuitry configured to perform the noted functions or one or more of the components can be implemented by one or more processors executing instructions to perform the noted functions.

An example UE procedure to set the energy detection threshold based on the second type of maximum energy detection threshold and/or the offset for the second type of maximum energy detection threshold is shown in FIG. 19. For instance, this example can be applied when the offset for the second type of maximum energy detection threshold is supported.

The UE determines whether the second type of maximum energy detection threshold is provided (1901).

If the second type of maximum energy detection threshold is provided to the UE, the UE can set the energy detection threshold (e.g., X_{Thresh}) to be less than or equal to the second type of maximum energy detection threshold provided to the UE (1906).

If the second type of maximum energy detection threshold is not provided to the UE, the UE can calculate a default maximum energy detection threshold (e.g., X′_{Thresh_max}) (1902), according to an example of this disclosure, and further determines whether an offset for the second type of maximum energy detection threshold is provided (1903).

If the offset for the second type of maximum energy detection threshold is provided to the UE, the UE applies the offset for the second type of maximum energy detection threshold to the default maximum energy detection threshold (e.g., X′_{Thresh_max}) to determine the second type of maximum energy detection threshold (1905), and set the energy detection threshold (e.g., X_{Thresh}) to be less than or equal to the second type of maximum energy detection threshold (1906).

If the offset for the second type of maximum energy detection threshold is not provided to the UE, the UE sets the second type of maximum energy detection threshold as the default maximum energy detection threshold (e.g., X′_{Thresh_max}) (1904), and set the energy detection threshold (e.g., X_{Thresh}) to be less than or equal to the second type of maximum energy detection threshold (1906).

In one embodiment, a UE applies the first type of maximum energy detection threshold (and/or the associated offset) and/or the second type of maximum energy detection threshold (and/or the associated offset) based on an example as described in this disclosure.

In one example, the at least one second type of maximum energy detection threshold (and/or the associated offset) can be applied for the channel access procedure after which the UE initializes a channel occupancy to perform sidelink transmission(s) and shares its channel occupancy to a gNB and/or other UE(s). For this example, whether the at least one second type of maximum energy detection threshold (and/or the associated offset) is provided or not can be used as an indication of whether the corresponding channel occupancy sharing is supported or not, respectively.

In one example, at least one second type of maximum energy detection threshold (and/or the associated offset) can be applied for the channel access procedure after which the UE initializes a channel occupancy to perform sidelink transmission(s) and shares its channel occupancy to other UE(s) for sidelink transmission(s) on the same channel.

In another example, at least one second type of maximum energy detection threshold (and/or the associated offset) can be applied for the channel access procedure after which the UE initializes a channel occupancy to perform sidelink transmission(s) and shares its channel occupancy to other UE(s) for uplink transmission(s) on the same channel.

In yet another example, at least one second type of maximum energy detection threshold (and/or the associated offset) can be applied for the channel access procedure after which the UE initializes a channel occupancy to perform sidelink transmission(s) and shares its channel occupancy to a gNB for downlink transmission(s) on the same channel.

In one example, the transmission from the UE that initializes a channel occupancy can be or include a scheduled sidelink transmission.

In another example, the transmission from the UE that initializes a channel occupancy can be or include a configured sidelink transmission.

In one example, if the at least one second type of maximum energy detection threshold (and/or the associated offset) is not provided, the transmission in the shared channel occupancy may not include any unicast transmissions and/or the transmission duration has an upper bound (e.g., 2 ms, which is 2, 4 or 8 symbols for 15, 30, or 60 kHz SCS respectively).

In another example, if the at least one second type of maximum energy detection threshold (and/or the associated offset) is not provided, the transmission in the shared channel occupancy may not include any groupcast transmissions and/or the transmission duration has an upper bound (e.g., 2 ms, which is 2, 4 or 8 symbols for 15, 30, or 60 kHz SCS respectively).

In one example, if the at least one second type of maximum energy detection threshold (and/or the associated offset) is provided to at least one second UE by a first UE, potentially with a further condition that the at least one second UE is provided an indication that other radio access technology is absent (e.g., by a higher layer parameter from a gNB and/or the first UE), the first UE may use its transmit power to determine the resulting at least one second type of maximum energy detection threshold.

In another example, if the at least one second type of maximum energy detection threshold (and/or the associated offset) is provided to at least one second UE by a first UE, potentially with a further condition that the at least one second UE is provided an indication that other radio access technology is absent (e.g., by a higher layer parameter from a gNB and/or the first UE), the first UE may use P_{CMAX_H,c} to determine the resulting at least one second type of maximum energy detection threshold.

In yet another example, if the at least one second type of maximum energy detection threshold (and/or the associated offset) is provided to at least one second UE by a first UE, potentially with a further condition that the at least one second UE is provided an indication that other radio access technology is absent (e.g., by a higher layer parameter from a gNB and/or the first UE), the first UE may use P_{CMAX} to determine the resulting at least one second type of maximum energy detection threshold.

In another example, the first type of maximum energy detection threshold (and/or the associated offset) can be applied for the channel access procedure after which the UE performs sidelink transmission when the second type of maximum energy detection threshold is not applied. In one instance, the first type of maximum energy detection threshold (and/or the associated offset) can be applied for all the cases of the channel access procedure after which the UE performs sidelink transmission, when the second type of maximum energy detection threshold is not supported.

In yet another example, the case that the first type of maximum energy detection threshold (and/or the associated offset) can be applied is the same as the case that the second type of maximum energy detection threshold (and/or the associated offset) can be applied, and there is no distinguish of the first or second type of maximum energy detection threshold (and/or the associated offset), e.g., the description on the applicability of the second type of maximum energy detection threshold (and/or the associated offset) in this disclosure can be applied to the first type of maximum energy detection threshold (and/or the associated offset) as well, and the description on the applicability of the first type of maximum energy detection threshold (and/or the associated offset) in this disclosure can be applied to the second type of maximum energy detection threshold (and/or the associated offset) as well.

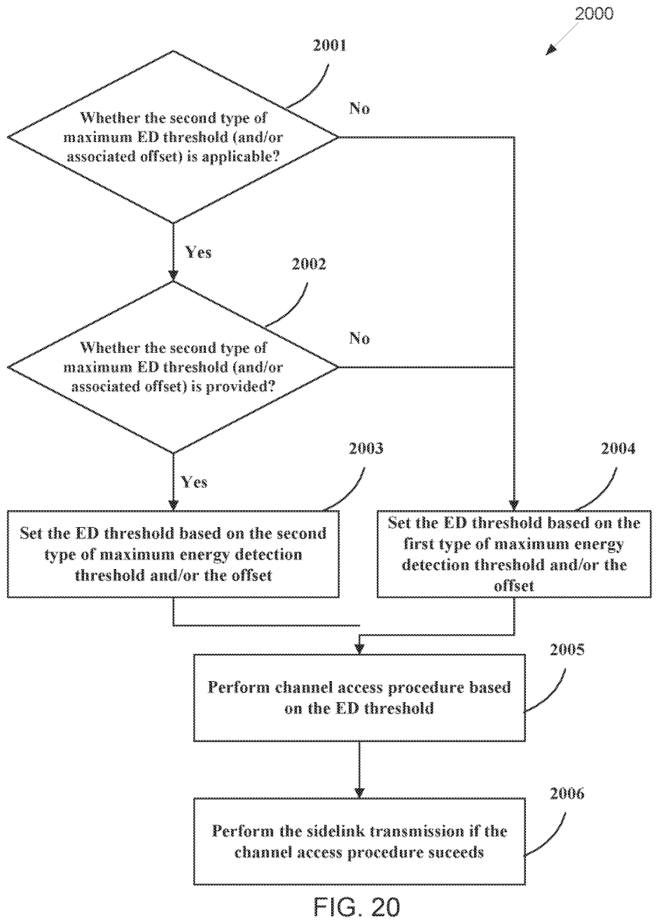

FIG. 20 illustrates a flowchart of a method 2000 for a UE procedure for sidelink transmission based on the maximum ED thresholds according to embodiments of the present disclosure. The embodiment of the method 2000 illustrated in FIG. 20 is for illustration only. The method 2000 as may be performed by a UE (e.g., 111-116 as illustrated in FIG. 1). One or more of the components illustrated in FIG. 20 can be implemented in specialized circuitry configured to perform the noted functions or one or more of the components can be implemented by one or more processors executing instructions to perform the noted functions.

An example UE procedure for sidelink transmission based on the maximum energy detection thresholds is shown in FIG. 20.

The UE determines whether the second type of maximum energy detection threshold (and/or the associated offset) is applicable for the sidelink transmission, based on the examples described in this disclosure (2001).

If the second type of maximum energy detection threshold (and/or the associated offset) is applicable for the sidelink transmission, the UE further determines whether the second type of maximum energy detection threshold (and/or the associated offset) is provided (2002).

If the second type of maximum energy detection threshold (and/or the associated offset) is provided, the UE sets the energy detection threshold based on the provided second type of maximum energy detection threshold (and/or the associated offset) (2003), according to examples described in this disclosure (e.g., as shown in FIG. 17 or FIG. 19).

If the second type of maximum energy detection threshold (and/or the associated offset) is not provided, the UE sets the energy detection threshold based on the first type of maximum energy detection threshold (and/or the associated offset) (2004), according to examples described in this disclosure (e.g., as shown in FIG. 16 or FIG. 18).

If the second type of maximum energy detection threshold (and/or the associated offset) is not applicable for the sidelink transmission, the UE sets the energy detection threshold based on the first type of maximum energy detection threshold (and/or the associated offset) (2004), according to examples described in this disclosure (e.g., as shown in FIG. 16 or FIG. 18).

The UE then performs channel access procedure based on the energy detection threshold (2005).

The UE performs the sidelink transmission if the channel access procedure succeeds (e.g., the sensing of the channel in the channel access procedure is idle) (2006).

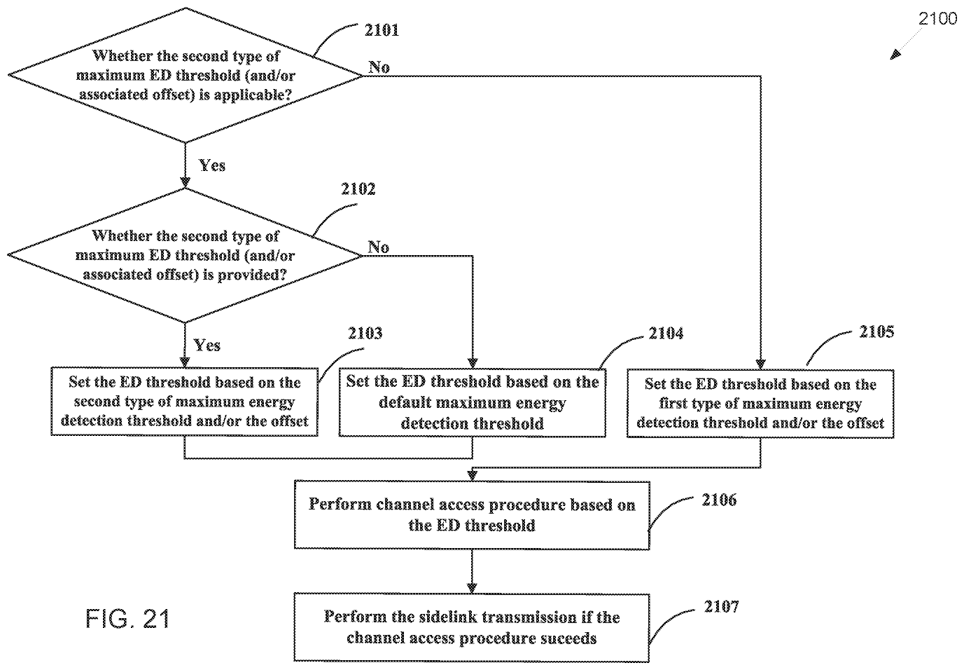

FIG. 21 illustrates a flowchart of a method 2100 for a UE procedure for sidelink transmission based on the maximum ED thresholds according to embodiments of the present disclosure. The embodiment of the method 2100 illustrated in FIG. 21 is for illustration only. The method 2100 as may be performed by a UE (e.g., 111-116 as illustrated in FIG. 1). One or more of the components illustrated in FIG. 21 can be implemented in specialized circuitry configured to perform the noted functions or one or more of the components can be implemented by one or more processors executing instructions to perform the noted functions.

Another example UE procedure for sidelink transmission based on the maximum energy detection thresholds is shown in FIG. 21.

The UE determines whether the second type of maximum energy detection threshold (and/or the associated offset) is applicable for the sidelink transmission, based on the examples described in this disclosure (2101).

If the second type of maximum energy detection threshold (and/or the associated offset) is applicable for the sidelink transmission, the UE further determines whether the second type of maximum energy detection threshold (and/or the associated offset) is provided (2102).

If the second type of maximum energy detection threshold (and/or the associated offset) is provided, the UE sets the energy detection threshold based on the provided second type of maximum energy detection threshold (and/or the associated offset) (2103), according to examples described in this disclosure (e.g., as shown in FIG. 17 or FIG. 19).

If the second type of maximum energy detection threshold (and/or the associated offset) is not provided, the UE sets the energy detection threshold based on the default maximum energy detection threshold, which is calculated by the UE, according to example described in this disclosure (2104).

If the second type of maximum energy detection threshold (and/or the associated offset) is not applicable for the sidelink transmission, the UE sets the energy detection threshold based on the first type of maximum energy detection threshold (and/or the associated offset) (2105), according to examples described in this disclosure (e.g., as shown in FIG. 16 or FIG. 18).

The UE then performs channel access procedure based on the energy detection threshold (2106).

The UE performs the sidelink transmission if the channel access procedure succeeds (e.g., the sensing of the channel in the channel access procedure is idle) (2107).

In one embodiment, a default maximum energy detection threshold (e.g., X′_{Thresh_max}) can be calculated by a UE.

In one example, if a UE is provided an indication that other radio access technology is absent (e.g., by a higher layer parameter from a gNB and/or another UE), the default maximum energy detection threshold can be calculated as: X′_{Thresh_max}=min(Tₘₐₓ+ΔTₘₐₓ,X_{reg}) where for one instance, Tₘₐₓ=10 log₁₀(3.16228·10⁻⁸(mW/MHz) BW(MHz)) and Tₘₐₓ is in dBm, wherein BW is the channel bandwidth in MHz; for another instance, X_{reg} is the maximum energy detection threshold defined by regulatory requirements in dBm when such requirements are defined, otherwise X_{reg} is same as Tₘₐₓ+ΔTₘₐₓ for yet another instance, ΔTₘₐₓ can be a value, e.g., fixed as 10 dB, or pre-configured, or provided by higher layer parameter from a gNB and/or a UE.

In another example, if a UE is not provided an indication that other radio access technology is absent (e.g., by a higher layer parameter from a gNB and/or another UE), the default maximum energy detection threshold can be calculated as:

$${X}_{Thresh \_ max}^{′} = max \{ \begin{matrix}- 72 + 10 \cdot {log}_{10} ( BW ( MHz ) / 20 ) dBm \\ min \{ {T}_{max} , {T}_{max} - {T}_{A} + ( {P}_{H} + 10 \cdot {log}_{10} ( BW ( MHz ) / 20 ) - {P}_{TX} ) \}\end{matrix} \}$$

where Tₘₐₓ=10 log₁₀(3.16228·10⁻⁸(mW/MHz) BW(MHz)) and Tₘₐₓ is in dBm, wherein BW is the channel bandwidth in MHz, P_{H} is fixed as 23 dBm.

In one example, P_{TX} is set to the value of P_{CMAX_H,c}.

In another example, P_{TX} is set to the value of P_{CMAX}.

In yet another example, P_{TX} is set to the maximum UE output power in dBm for the channel.

In one example, T_{A} is fixed, e.g., as 10 dB.

In another example, T_{A} is set to a smaller value for transmission with a discovery burst (e.g., 5 dB), and T_{A} is set to a larger value otherwise (e.g., 10 dB). For instance, a discovery burst can be referring to the transmissions allowed to perform quick channel access procedure, e.g., including S-SS/PSBCH block and/or PSFCH transmissions.

In yet another example, T_{A} can be set to a value based on the priority (e.g., transmission priority) of the associated transmission. For instance, T_{A} can be set to a smaller value if the priority (e.g., transmission priority) of the associated transmission is higher.

In one embodiment, a message including channel occupancy sharing information can be transmitted by a first UE to at least one second UE on sidelink.

In one example, the message can be included in an SCI format. For one sub-example, the SCI format can be SCI format 1-A. For another sub-example, the SCI format can be SCI format 2-A. For yet another sub-example, the SCI format can be SCI format 2-B. For yet another sub-example, the SCI format can be SCI format 2-C. For yet another sub-example, the SCI format can be a new SCI format other than the sub-examples above.

In another example, the message can be included in a higher layer parameter transmitted from the first UE to the at least one second UE (e.g., PC5 RRC parameter).

In yet another example, the message can be transmitted over a sidelink channel. For one sub-example, the sidelink channel can be PSCCH. For another sub-example, the sidelink channel can be PSSCH. For yet another sub-example, the sidelink channel can be PSFCH.

In one example, if a first UE initializes a channel occupancy and shares the channel occupancy with at least one second UE, wherein the transmission from the first UE is or includes configured sidelink transmission, the at least one second UE may transmit a transmission that follows the configured sidelink transmission by the first UE, according to the message including channel occupancy sharing information can be transmitted by the first UE to at least one second UE.

In one example, the at least one second UE can be configured with a set of channel occupancy sharing information (e.g., using a table), wherein each channel occupancy sharing information includes at least one of a time domain offset value, a time domain duration value, or a channel access priority class (CAPC), or includes that the channel occupancy sharing is not available. The message including channel occupancy sharing information can be determined as one from the set of channel occupancy sharing information (e.g., determines as one row from the table). The bitwidth of the message can be based on the size of the set (e.g., number of rows in the table).

In one example, the second UE can be configured with channel occupancy sharing information including a time domain offset value. The message including channel occupancy sharing information can be determined as whether to use the configured channel occupancy sharing information including a time domain offset value to determine the channel occupancy sharing. The bitwidth of the message can be 1.

In one embodiment, the indication can be whether the second type of maximum energy detection threshold is provided to the second UE, e.g., if the second type of maximum energy detection threshold is provided to the second UE, the first sub-example is used; and if the second type of maximum energy detection threshold is not provided to the second UE, the second sub-example is used.

In another embodiment, when the first UE provides multiple indications of the information on channel occupancy sharing information (e.g., other than channel occupancy sharing information being not available), the information for sidelink transmissions in the shared channel occupancy (e.g., configured SL transmissions) may be consistent from the multiple indications (e.g., consistent starting timing for transmission, and/or consistent transmission duration).

In yet another embodiment, if the at least one second UE is provided with the second type of maximum energy detection threshold, the second UE sets the maximum energy detection threshold as the provided second type of maximum energy detection threshold for the channel access procedure associated with its transmission, if at least one of the following conditions satisfies: the first UE does not provide the message including the channel occupancy sharing information in its sidelink transmission (e.g., the sidelink transmission is a scheduled sidelink transmission), or when the first UE provides the message including the channel occupancy sharing information wherein the information is other than channel occupancy sharing information being not available (e.g., the sidelink transmission is a configured sidelink transmission and the channel occupancy is shared).

In yet another embodiment, if the at least one second UE is provided with the message including channel occupancy sharing information indicating that the channel occupancy sharing is not available, the at least one second UE may assume the channel occupancy initialized by the first UE is not shared for transmission by the at least one second UE.

In yet another embodiment, if the at least one second UE is provided with the message including channel occupancy sharing information indicating at least one of a time domain offset value, a time domain duration value, or a channel access priority class, the at least one second UE may assume the channel occupancy initialized by the first UE can be shared for transmission by the at least one second UE, and the transmission starting from a slot determined based on the indicated time domain offset value, and/or with a transmission duration given by the indicated time domain duration value, and/or with a channel access procedure associated with the indicated channel access priority class. For one instance, the transmission can start from the slot with index n+O, wherein n is index of the slot where the message is received by the at least one second UE, and O is given by the indicated time domain offset value.

In yet another embodiment, if the at least one second UE is provided with the message including channel occupancy sharing information indicating a time domain offset value, the at least one second UE may assume the channel occupancy initialized by the first UE can be shared for transmission by the at least one second UE. For one instance, the transmission can occur in the slot within index n+O, wherein n is index of the slot where the message is received by the at least one second UE, and O is given by the indicated time domain offset value. For another instance, the transmission can occur 14·O symbols from the end of the slot where the message is received by the at least one second UE, and O is given by the indicated time domain offset value.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system operating with a shared spectrum channel access, the UE comprising:
a transceiver configured to receive a sidelink control information (SCI) format over a sidelink channel; and
a processor operably coupled to the transceiver, the processor configured to:
determine, from the SCI format, at least one of:
time domain information for a channel occupancy,
frequency domain information for the channel occupancy, and
a sidelink channel access procedure; and
perform the sidelink channel access procedure before a sidelink transmission,
wherein the transceiver is further configured to transmit, upon successfully performing the sidelink channel access procedure, the sidelink transmission over the sidelink channel within the channel occupancy based on the time domain information or the frequency domain information for the channel occupancy.

2. The UE of claim 1, wherein:
the time domain information for the channel occupancy is a remaining channel occupancy duration from a slot where the SCI format is received, and
the remaining channel occupancy duration is in a unit of a slot.

3. The UE of claim 1, wherein:
the frequency domain information for the channel occupancy is an indication on available resource block (RB) sets for sidelink transmissions,
the indication is a bitmap, and
each bit in the bitmap corresponds to a RB set.

4. The UE of claim 1, wherein the sidelink channel access procedure includes at least one of a sidelink channel access procedure type or a channel access priority class (CAPC).

5. The UE of claim 4, wherein the sidelink channel access procedure type is one of:
a first type of sidelink channel access procedure where a time duration spanned by sensing slots that are sensed to be idle before a sidelink transmission is random,
a second type of sidelink channel access procedure where a time duration spanned by sensing slots that are sensed to be idle before a sidelink transmission is deterministic as a first value of 25 microseconds,
a third type of sidelink channel access procedure where a time duration spanned by sensing slots that are sensed to be idle before a sidelink transmission is deterministic as a second value of 16 microseconds, or
a fourth type of sidelink channel access procedure where a time duration spanned by sensing slots that are sensed to be idle before a sidelink transmission is deterministic as a third value of 0 microseconds.

6. The UE of claim 4, wherein a value of the CAPC (p) is one of:
p=1, and associated sidelink channel access procedure parameters are determined as mₚ=2, CW_{min,p}=3, CW_{max,p}=7, and T_{mcot,p}=2 ms;
p=2, and associated sidelink channel access procedure parameters are determined as mₚ=2, CW_{min,p}=7, CW_{max,p}=15, and T_{mcot,p}=4 ms;
p=3, and associated sidelink channel access procedure parameters are determined as mₚ=3, CW_{min,p}=15, CW_{max,p}=1023, and T_{mcot,p}=6 ms; or
p=4, and associated sidelink channel access procedure parameters are determined as mₚ=7, CW_{min,p}=15, CW_{max,p}=1023, and T_{mcot,p}=6 ms.

7. The UE of claim 1, wherein the SCI format is determined as one of:
a SCI format 1-A,
a SCI format 2-A,
a SCI format 2-B, or
a SCI format 2-C.

8. The UE of claim 1, wherein the processor is further configured to determine, from the SCI format, a first identification (ID) associated with a first UE that initiates the channel occupancy.

9. The UE of claim 8, wherein the processor is further configured to determine, from the SCI format, a second identification (ID) associated with a second UE that shares the channel occupancy initiated by the first UE.

10. The UE of claim 1, wherein the processor is further configured to:
determine, from the SCI format, an indication of a cyclic prefix (CP) extension value; and
extend a CP of a first orthogonal frequency division multiplexing (OFDM) symbol of the sidelink transmission by the CP extension value.

11. A method of a user equipment (UE) in a wireless communication system operating with a shared spectrum channel access, the method comprising:
receiving a sidelink control information (SCI) format over a sidelink channel;
determining, from the SCI format, at least one of:
time domain information for a channel occupancy,
frequency domain information for the channel occupancy, and
a sidelink channel access procedure;
performing the sidelink channel access procedure before a sidelink transmission; and
transmitting, upon successfully performing the sidelink channel access procedure, the sidelink transmission over the sidelink channel within the channel occupancy based on the time domain information or the frequency domain information for the channel occupancy.

12. The method of claim 11, wherein:
the time domain information for the channel occupancy is a remaining channel occupancy duration from a slot where the SCI format is received, and
the remaining channel occupancy duration is in a unit of a slot.

13. The method of claim 11, wherein:
the frequency domain information for the channel occupancy is an indication on available resource block (RB) sets for sidelink transmissions,
the indication is a bitmap, and
each bit in the bitmap corresponds to a RB set.

14. The method of claim 11, wherein the sidelink channel access procedure includes at least one of a sidelink channel access procedure type or a channel access priority class (CAPC).

15. The method of claim 14, wherein the sidelink channel access procedure type is one of:
a first type of sidelink channel access procedure where a time duration spanned by sensing slots that are sensed to be idle before a sidelink transmission is random,
a second type of sidelink channel access procedure where a time duration spanned by sensing slots that are sensed to be idle before a sidelink transmission is deterministic as a first value of 25 microseconds,
a third type of sidelink channel access procedure where a time duration spanned by sensing slots that are sensed to be idle before a sidelink transmission is deterministic as a second value of 16 microseconds, or
a fourth type of sidelink channel access procedure where a time duration spanned by sensing slots that are sensed to be idle before a sidelink transmission is deterministic as a third value of 0 microseconds.

16. The method of claim 14, wherein a value of the CAPC (p) is one of:
p=1, and associated sidelink channel access procedure parameters are determined as mₚ=2, CW_{min,p}=3, CW_{max,p}=7, and T_{mcot,p}=2 ms;
p=2, and associated sidelink channel access procedure parameters are determined as mₚ=2, CW_{min,p}=7, CW_{max,p}=15, and T_{mcot,p}=4 ms;
p=3, and associated sidelink channel access procedure parameters are determined as mₚ=3, CW_{min,p}=15, CW_{max,p}=1023, and T_{mcot,p}=6 ms; or
p=4, and associated sidelink channel access procedure parameters are determined as mₚ=7, CW_{min,p}=15, CW_{max,p}=1023, and T_{mcot,p}=6 ms.

17. The method of claim 11, wherein the SCI format is determined as one of:
a SCI format 1-A,
a SCI format 2-A,
a SCI format 2-B, or
a SCI format 2-C.

18. The method of claim 11, further comprising determining, from the SCI format, a first identification (ID) associated with a first UE that initiates the channel occupancy.

19. The method of claim 18, further comprising determining, from the SCI format, a second identification (ID) associated with a second UE that shares the channel occupancy initiated by the first UE.

20. The method of claim 11, further comprising:
determining, from the SCI format, an indication of a cyclic prefix (CP) extension value; and
extending a CP of a first orthogonal frequency division multiplexing (OFDM) symbol of the sidelink transmission by the CP extension value.
